(19) United States
(12) Patent Application Publication
(10) Pub. No.: US 2020/0270932 A1
(43) Pub. Date: Aug. 27, 2020

(54) Continuous Sill for Doors with Sidelites

(71) Applicant: Gregory A Header, Richland, PA (US)

(72) Inventor: Gregory A Header, Richland, PA (US)

(21) Appl. No.: 16/283,766

(22) Filed: Feb. 23, 2019

(51) Int. Cl. E06B 1/70

(52) U.S. Cl. CPC E06B 1/70; E06B 2001/707

(57) ABSTRACT

Disclosed is a sill assembly and sill that can be positioned continuously under doorways with swing doors, sidelites, and vertical door frame members such as vertical jambs, and mull posts, or the vertical members of sidelites. One variation of the sill assembly can be used for inswing doors while another can be used for outswing doors. The sill assembly includes a backstop and optionally can include end dams. These in combination with the structure of the sill assembly shed water away from the building structure and allow for the possibility of the sill assembly being installed without an additional sill pan or flashing. The sill assembly can optionally include one or more thermal breaks. The sill assembly can be structured so the thermal breaks of the door, sidelites, and vertical door frame members all align with the thermal breaks of the sill assembly.

### BACKGROUND

The present disclosure relates to sills within a doorway where the doorway can include one or more doors and one or more sidelites. A sidelite, also spelled sidelight, is a framed glass, acrylic, or other glazing or infill panels that flanks the side of a door. Fixed sidelites have a non-operable glazing or infill panel that does not open. Vented sidelites can have an operable glazing or infill panel; i.e., the glazing or infill panel opens and closes within the frame. A sidelite can also be an infill panel such as wood panel, or composite panel. A composite panel can typically be constructed of aluminum over foam.

Sills can create an air or moisture barrier between the inside and outside of a doorway. For example, a sill can weather seal the bottom of the door, preventing water and outside air from entering the building from underneath the door. A sill pan, or pan flashing, can be placed between the sill and the floor. The sill pan prevents water from collecting and leaking through the sill by diverting water back into the outside environment. The sill pan typically has vertical structures, or dams, on opposite ends to prevent water from infiltrating the vertical framing posts or vertical jambs.

Doorways with both doors and sidelites typically have separate sills under the door and under each sidelite. For example, a doorway with a door and two sidelites would typically have three sills. One sill would be positioned under the door between the vertical framing members, or vertical jambs, that surround the door. A second sill would be positioned beneath one of the sidelites between the vertical framing members, for example, vertical jambs and/or mull posts, that frame the sidelite. A third sill would be positioned beneath the other sidelite between the vertical jambs and mull posts that surround that sidelite. Sill pans could be placed under each sill to prevent water infiltration and protect the corresponding vertical jambs.

Recently, sills have been developed that run continuously under both doors and the accompanying sidelites. These have the potential advantage of simpler installation and less parts than installing a separate sill for the door and each sidelite as described above.

### SUMMARY

The inventor set out to create an improved continuous sill assembly optimized for glazed door and sidelite assemblies. The inventor envisions that there are a number of different ways to implement his improved sill assembly for use with both outswing and inswing doors. Three basic variations along with sub-variations are described in detail within the Description section.

These three variations have common features and advantages. First, the sill bodies all include backstops. The backstops align the closed door in the same vertical plane as the sidelites. The backstops prevent air and water infiltration by creating a vertical seal against the door and sidelites. Second, the sill assemblies include one or more horizontal surfaces positioned across the length of either the sill body or sill deck. These horizontal surfaces are structured to seat sidelites and vertical frame members such as mull posts, vertical jambs, or sidelite stiles. For the sill assembly without a sill deck, these horizontal surfaces are located on the sill body. For sill assemblies with one or more sill decks, these horizontal surfaces are located on the sill decks. Third, the sill body in combination with end dams, are shaped to shed water away from the building. This allows for the possibility of using the sill body as its own sill pan and potentially eliminates the need for additional flashing. Fourth, the sill assembly can optionally include thermal breaks, such as thermal struts, structural foam, or other thermally insulating material capable of forming rigid structures. With the aid of the backstop, the thermal breaks in the sill assembly can be aligned over thermal breaks in the doors, sidelites, and vertical frame members. Aligning the thermal breaks can significantly improve the thermal efficiency of the doorway assembly by reducing heat transfer between the inside and outside of the doorway structure. Fifth, sill assemblies can be structured so the bottom lengthwise edge of each sidelite is collinear with the bottom edge of the door. This can help the doorway have a more uniform visual impression.

This Summary introduces a selection of concepts in simplified form that are described the Description. The Summary is not intended to identify essential features or limit the scope of the claimed subject matter.

### DRAWINGS

FIG. 1 illustrates a first example of a continuous sill for use with an outswing door and a sidelite, in front perspective view.

FIG. 2 illustrates the continuous sill of FIG. 1 in exploded front perspective view.

FIG. 3 illustrates a portion the continuous sill of FIG. 1 enlarged for magnification purposes and with the end dam removed for clarity.

FIG. 4 illustrates a top view of the continuous sill of FIG. 1.

FIG. 5 illustrates a section view of the continuous sill of FIG. 4 taken along section lines 5-5.

FIG. 6 illustrates a section view of the continuous sill of FIG. 4 taken along section lines 6-6.

FIG. 7 illustrates a doorway assembly including an outswing door, a sidelite, and incorporating the continuous sill of FIG. 1, in front perspective view.

FIG. 8 illustrates a front view of the doorway assembly of FIG. 7.

FIG. 9 illustrates a rear view of the doorway assembly of FIG. 7.

FIG. 10 illustrates a section view of the doorway assembly of FIG. 8 taken along section lines 10-10.

FIG. 11 illustrates a section view of the doorway assembly of FIG. 8 taken along section lines 11-11.

FIG. 12 illustrates a section view of the doorway assembly of FIG. 8 taken along section lines 12-12.

FIG. 13 illustrates a detail view of the doorway assembly of FIG. 7, enlarged for magnification purposes.

FIG. 14 illustrates a second example of a continuous sill for use with an outswing door and a sidelite, in front perspective view.

FIG. 15 illustrates the continuous sill of FIG. 14 in exploded front perspective view.

FIG. 16 illustrates a top view of the continuous sill of FIG. 14.

FIG. 17 illustrates a section view of the continuous sill of FIG. 16 taken along section lines 17-17.

FIG. 18 illustrates a section view of the continuous sill of FIG. 16 taken along section lines 18-18.

FIG. 19 illustrates a section view of the continuous sill of FIG. 16 taken along section lines 19-19.

FIG. 20 illustrates a side exploded view of the continuous sill of FIG. 14.

FIG. 21 illustrates a front view of a doorway assembly including an outswing door, sidelite, and incorporating the continuous sill of FIG. 14.

FIG. 22 illustrates a rear view of a doorway assembly including a swing door, sidelite, and incorporating the continuous sill of FIG. 14.

FIG. 23 illustrates a section view of the doorway assembly of FIG. 21 taken along section lines 23-23.

FIG. 24 illustrates a section view of the doorway assembly of FIG. 21 taken along section lines 24-24.

FIG. 25 illustrates a section view of the doorway assembly of FIG. 21 taken along section lines 25-25.

FIG. 26 illustrates a portion of the doorway assembly of FIG. 21, in front perspective view, and enlarged for magnification purposes.

FIG. 27 illustrates a front perspective view of a doorway assembly including an outswing door, two sidelites, a continuous header, and incorporating an extended version of the continuous sill of FIG. 14.

FIG. 28 illustrates a rear perspective view of the doorway assembly of FIG. 27.

FIG. 29 illustrates an extended version of the continuous sill of FIG. 14 capable of being used with an outswing door and three sidelites.

FIG. 30 illustrates an exploded front perspective view of the continuous sill of FIG. 29.

FIG. 31 illustrates a front perspective view of a doorway assembly including a swing door, three sidelites and incorporating the continuous sill of FIG. 29.

FIG. 32 illustrates a rear perspective view of the doorway assembly of FIG. 29.

FIG. 33 illustrates a continuous sill, similar to the continuous sill of FIG. 14, in front perspective view, with the addition of alignment portion brackets for aligning and securing the sidelites and door jambs.

FIG. 34 illustrates the continuous sill of FIG. 33 in exploded perspective view.

FIG. 35 illustrates a top view of the continuous sill of FIG. 33.

FIG. 36 illustrates a section view of FIG. 35 taken along section lines 36-36.

FIG. 37 illustrates a section view of FIG. 35 taken along section lines 37-37.

FIG. 38 illustrates a section view of FIG. 35 taken along section lines 38-38.

FIG. 39 illustrates an exploded side view of the sill of FIG. 33 with the end dam removed for clarity.

FIG. 40 illustrates a portion of the continuous sill of FIG. 34, in front perspective view, and enlarged for magnification purposes.

FIG. 41 illustrates an alternative section view of the doorway assembly of FIG. 21 taken along section lines 24-24 and utilizing the continuous sill of FIG. 33.

FIG. 42 illustrates an alternative section view of the doorway assembly of FIG. 21 taken along section lines 23-23 and utilizing the continuous sill of FIG. 33.

FIG. 43 illustrates an alternative section view of the doorway assembly of FIG. 21 taken along section lines 25-25 and utilizing the continuous sill of FIG. 33.

FIG. 44 illustrates a continuous sill for use with an inswing door and a sidelite, in front perspective view.

FIG. 45 illustrates the continuous sill of FIG. 44 in exploded perspective view.

FIG. 46 illustrates a top view of the continuous sill of FIG. 44.

FIG. 47 illustrates a section view of the continuous sill of FIG. 46 taken along section lines 47-47.

FIG. 48 illustrates a section view of the continuous sill of FIG. 46 taken along section lines 48-48.

FIG. 49 illustrates a section view of the continuous sill of FIG. 46 taken along section lines 49-49.

FIG. 50 illustrates an exploded side view of the sill of FIG. 44 with the end dam removed for clarity.

FIG. 51 illustrates a front view of a doorway assembly including an inswing door, sidelite, and incorporating the continuous sill of FIG. 44.

FIG. 52 illustrates a rear view of the doorway assembly of FIG. 51.

FIG. 53 illustrates a section view of the doorway assembly of FIG. 51 taken along section lines 53-53.

FIG. 54 illustrates a section view of the doorway assembly of FIG. 51 taken along section lines 54-54.

FIG. 55 illustrates a section view of the doorway assembly of FIG. 51 taken along section lines 55-55.

FIG. 56 illustrates a detail view of the doorway assembly of FIG. 52, enlarged for magnification purposes.

FIG. 57 illustrates a continuous sill, similar to the continuous sill of FIG. 44, in front perspective view, with the addition of alignment portion brackets for aligning and securing the sidelites and door jambs.

FIG. 58 illustrates the continuous sill of FIG. 57 in exploded perspective view.

FIG. 59 illustrates a top view of the continuous sill of FIG. 57.

FIG. 60 illustrates a section view of the continuous sill of FIG. 59 taken along section lines 60-60.

FIG. 61 illustrates a section view of the continuous sill of FIG. 59 taken along section lines 61-61.

FIG. 62 illustrates a section view of the continuous sill of FIG. 59 taken along section lines 62-62.

FIG. 63 illustrates an exploded side view of the continuous sill of FIG. 57.

FIG. 64 illustrates a detail view of the continuous sill of FIG. 58, enlarged for magnification purposes.

FIG. 65 illustrates an alternative section view of the doorway assembly of FIG. 51 taken along section lines 53-53 and utilizing the continuous sill of FIG. 57.

FIG. 66 illustrates an alternative section view of the doorway assembly of FIG. 51 taken along section lines 55-55 and utilizing the continuous sill of FIG. 57.

FIG. 67 illustrates an alternative section view of the doorway assembly of FIG. 51 taken along section lines 54-54 and utilizing the continuous sill of FIG. 57.

FIG. 68 illustrates an alternative version of the section view of FIG. 42 with an alternative version of the alignment portions.

FIG. 69 illustrates an alternative version of the section view of FIG. 66 with an alternative version of the alignment portions.

FIG. 70 illustrates an alternative version of the section view of FIG. 10 illustrating the sidelite secured to the backstop by a spring clip, bracket, and threaded fastener.

FIG. 71 illustrates an alternative version of the section view of FIG. 12 illustrating the sidelite secured to the backstop by a spring clip, bracket, and threaded fastener.

### DESCRIPTION

The terms “left,” “right,” “top, “bottom,” “upper,” “lower,” and “side,” are relative terms used throughout this Description to help the reader understand the figures. Unless otherwise indicated, these do not denote absolute direction or orientation and do not imply a particular preference. When describing doorways, doors, sidelites, or sill assemblies, the term “front” refers to the portion of the doorway, door, sidelite, or sill assembly that faces in the direction that the door opens. The term “rear” refers to the portion of the doorway, door, sidelite, or sill assembly that faces away from the direction that the door opens. For a doorway with an inswing door, i.e., a door opens into an interior environment, front refers to portions of the doorway that face the interior environment, and rear refers to portions of the doorway that face the exterior environment. For a doorway with an outswing door, i.e. a door that opens into the exterior environment, front refers to portions of the doorway that face the exterior environment and rear refers to portions of the doorway that face the interior environment. The term “doorway,” refers to a fenestration opening that can include one or more doors, sidelites, and door frame members. A “back stop” would be positioned on the rear portion of the doorway. For an outswing door, the back stop would be positioned along the side of the sill assembly that faces the interior environment. For an inswing door, the back stop would be positioned along the side of the sill assembly that faces the exterior environment. The term “door frame member” can refer to door headers, sidelite stiles, mull posts, vertical door jambs, or other structures that can be used to support or frame the doorway. The term “vertical door frame member” can refer to any vertical frame member within a doorway; for example, a vertical jamb, a sidelite stile, or mull post. The term “door opening” refers to the passage created by an open door. Throughout the figures, the designation “interior” refers to the interior environment and “exterior” refers to the exterior environment. Specific dimensions are intended to help the reader understand the scale and advantage of the disclosed material. Dimensions given are typical and the claimed invention is not limited to the recited dimensions.

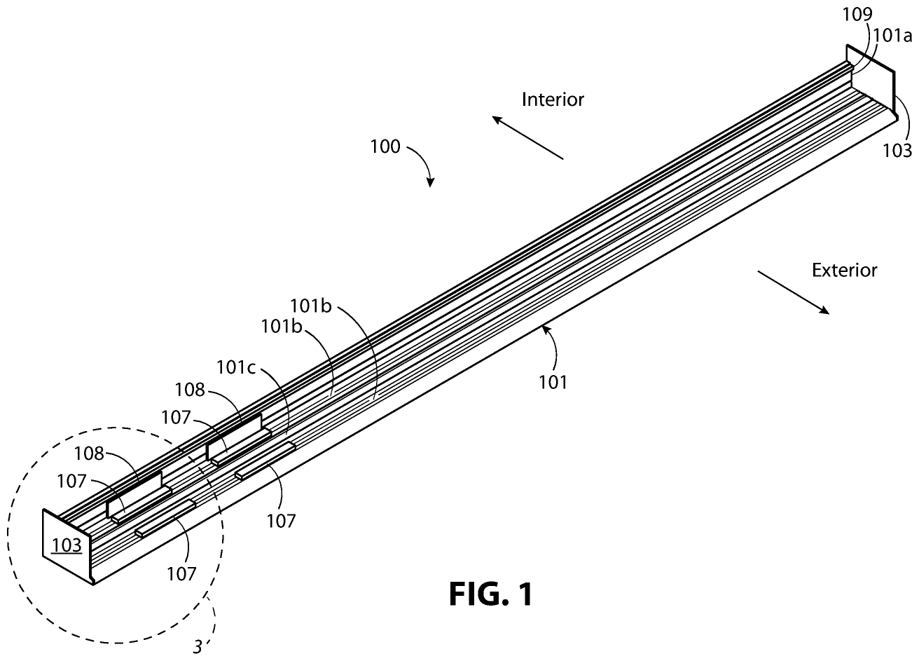

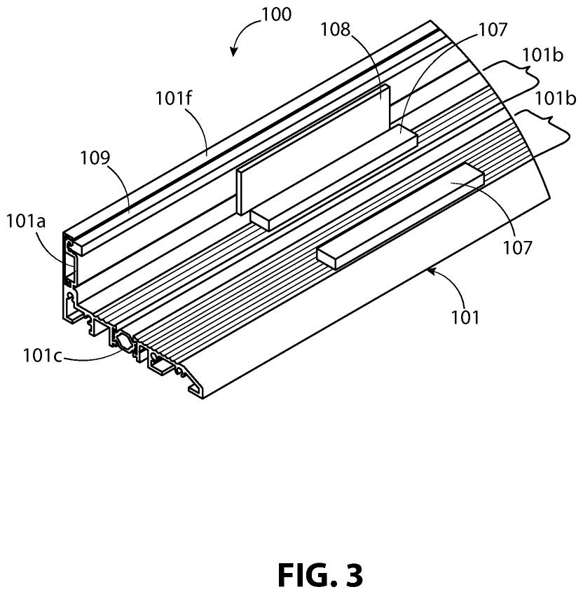

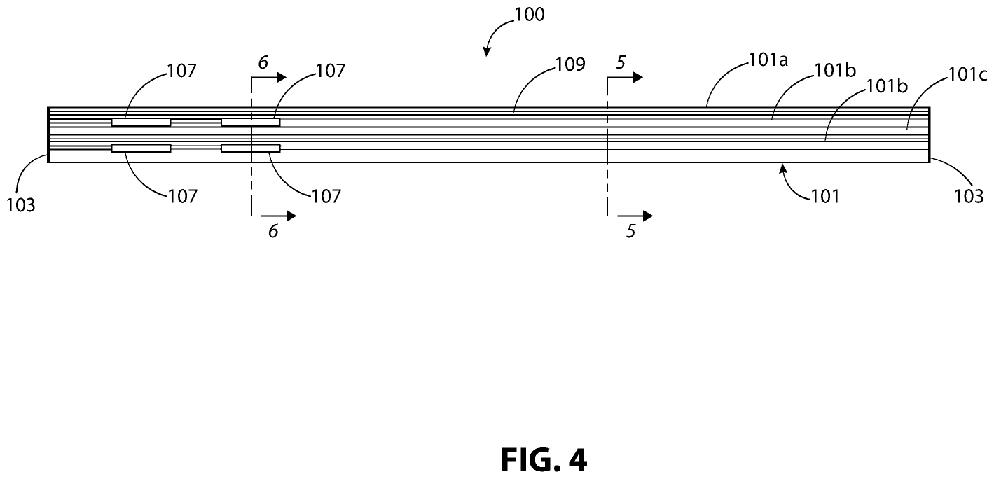

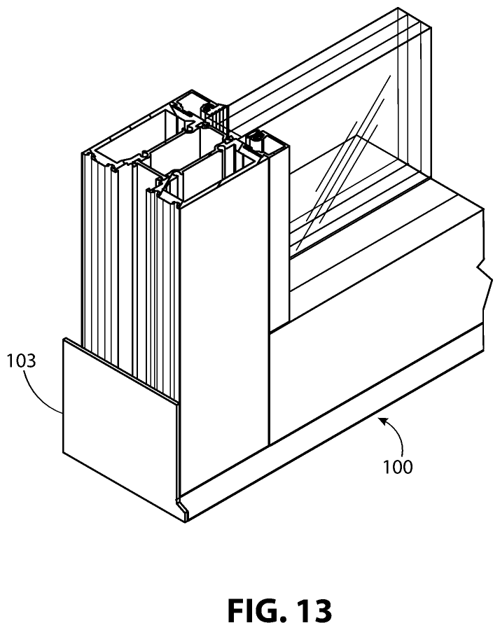

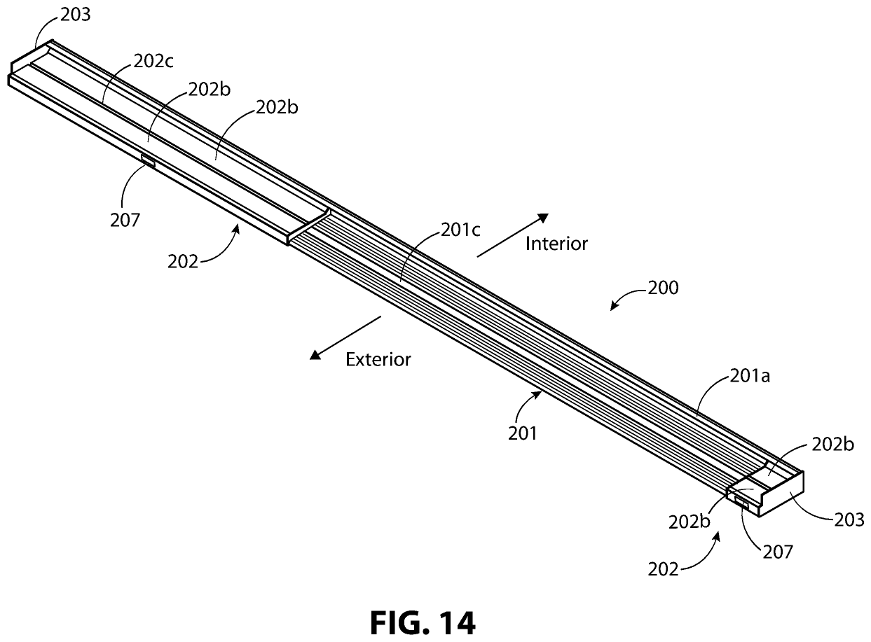

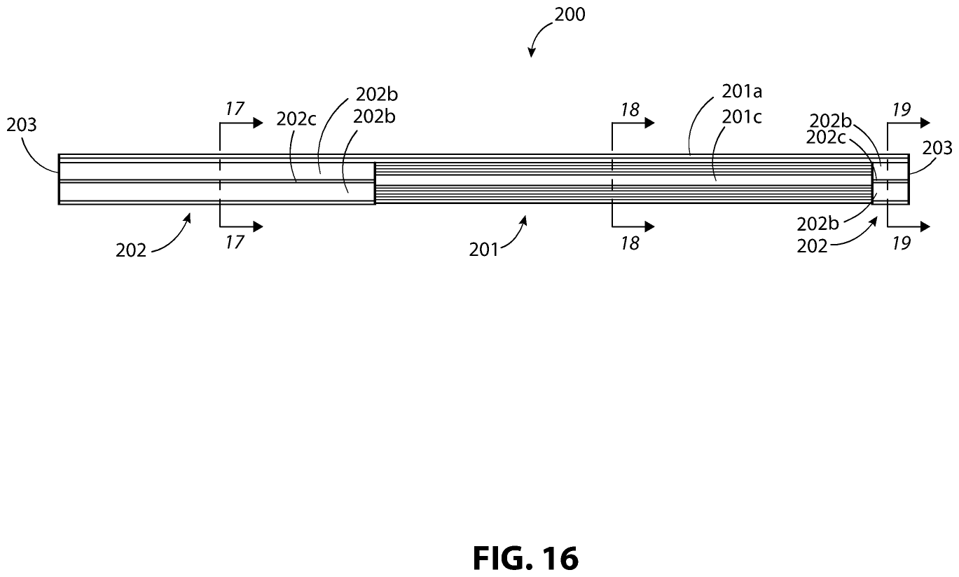

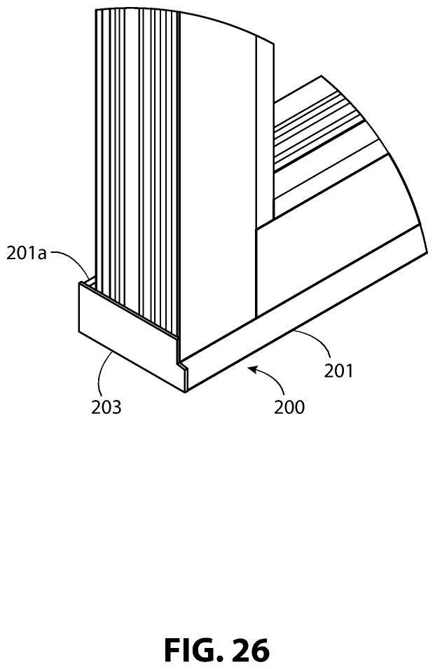

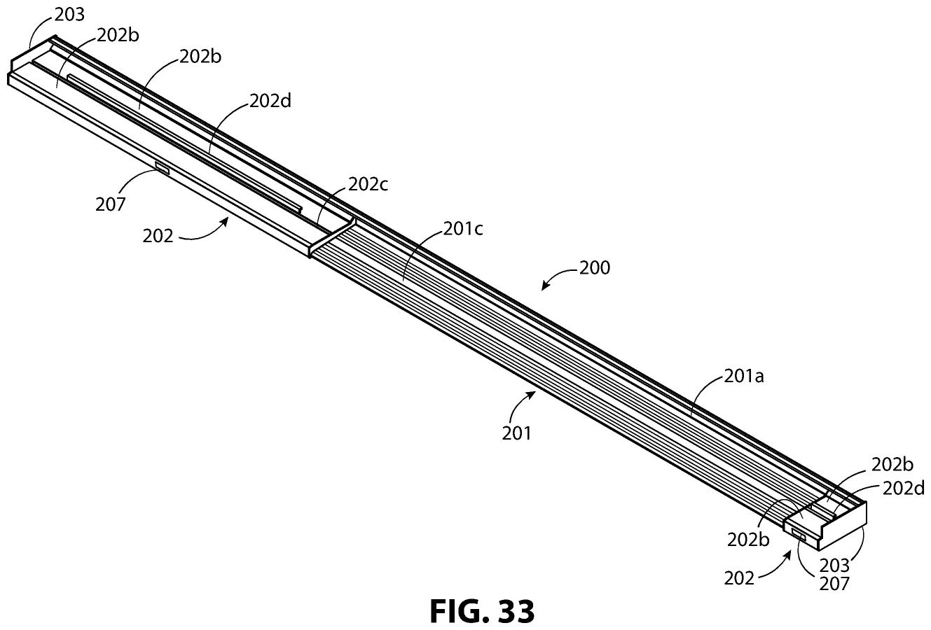

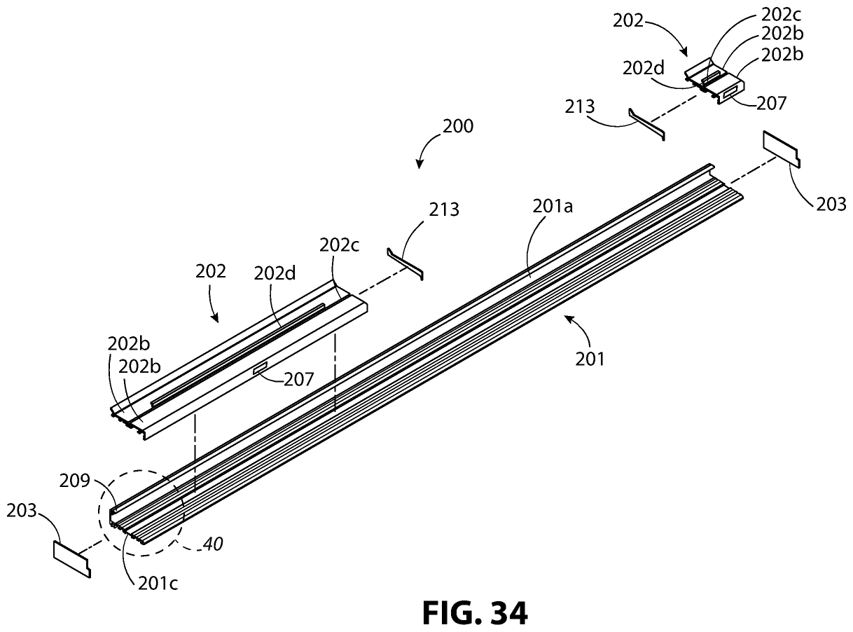

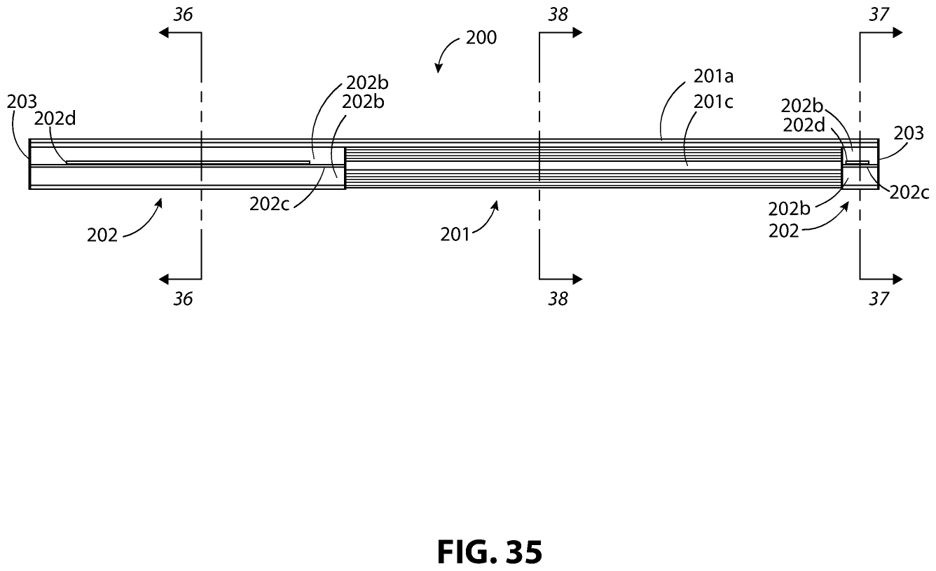

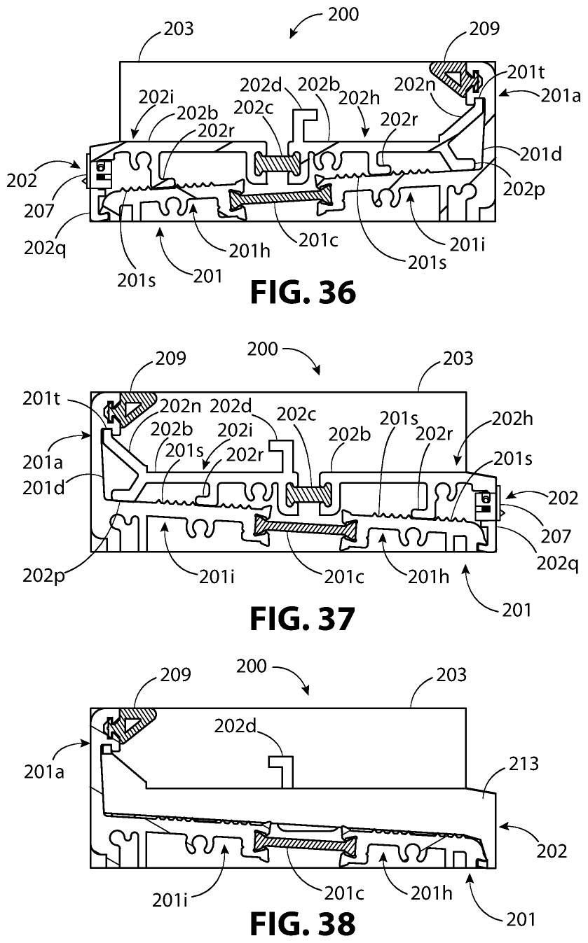

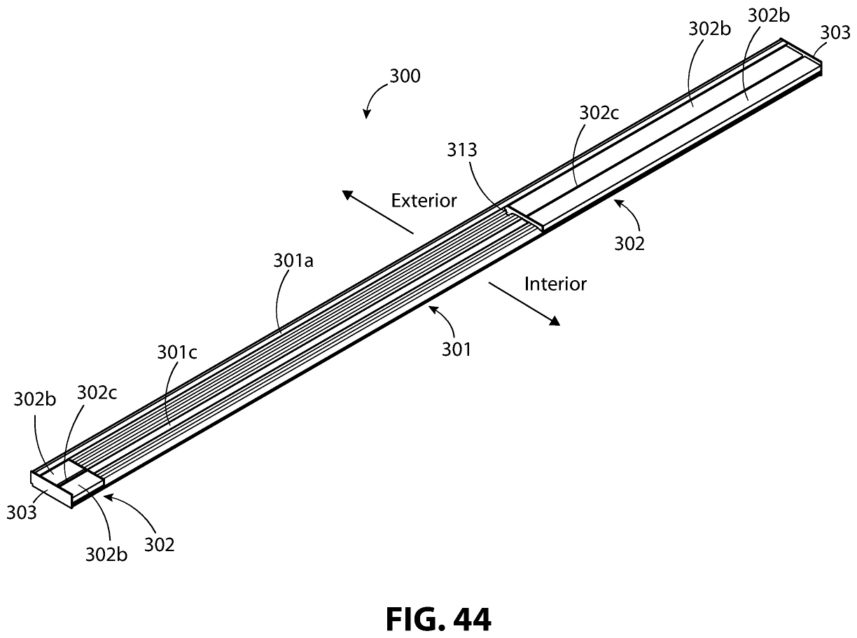

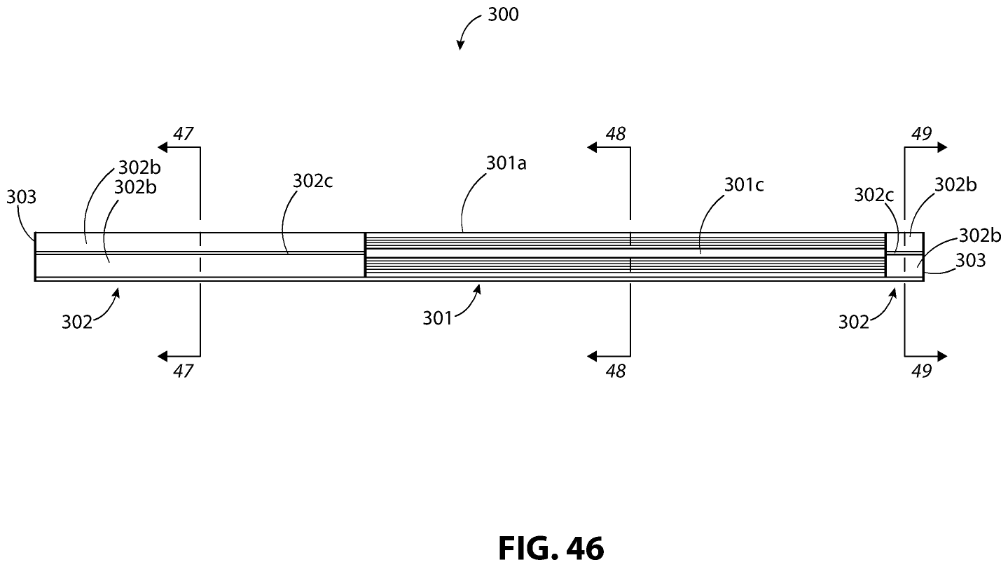

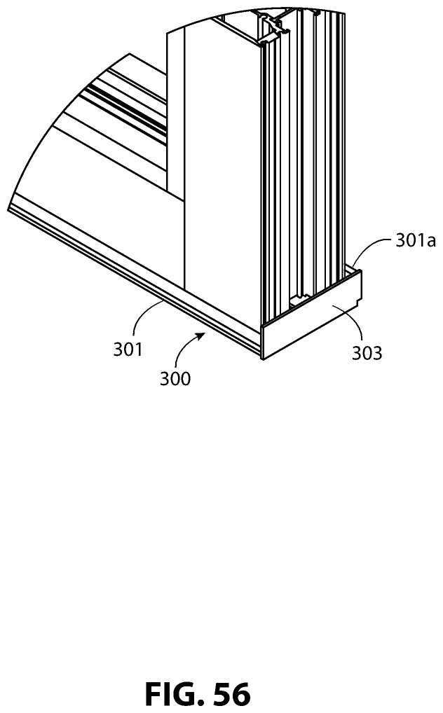

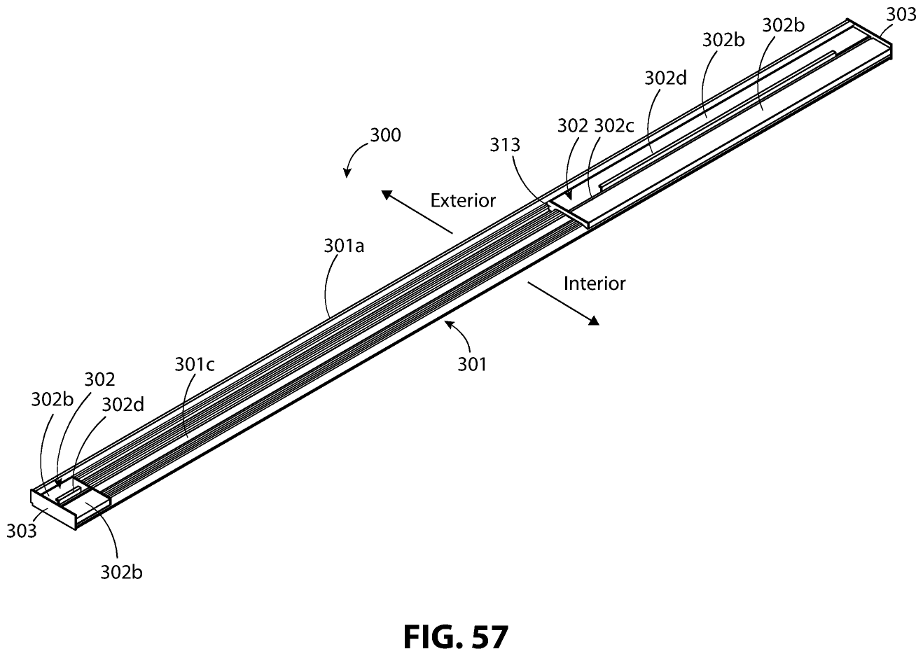

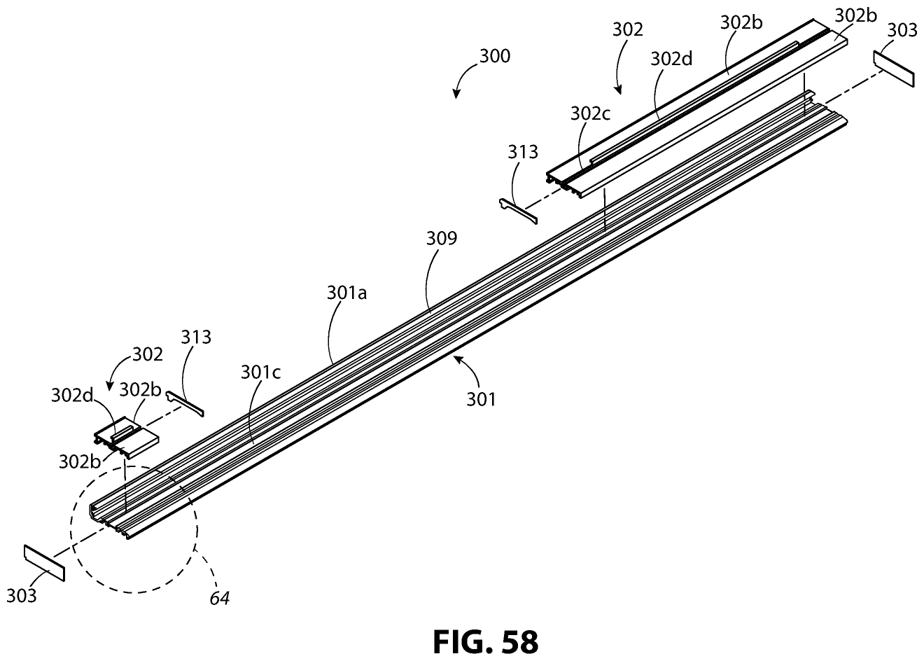

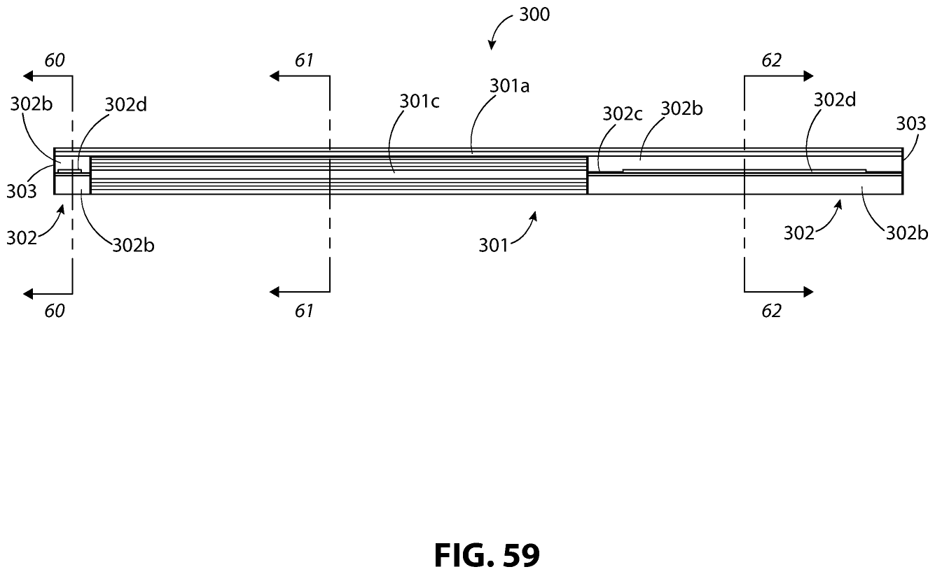

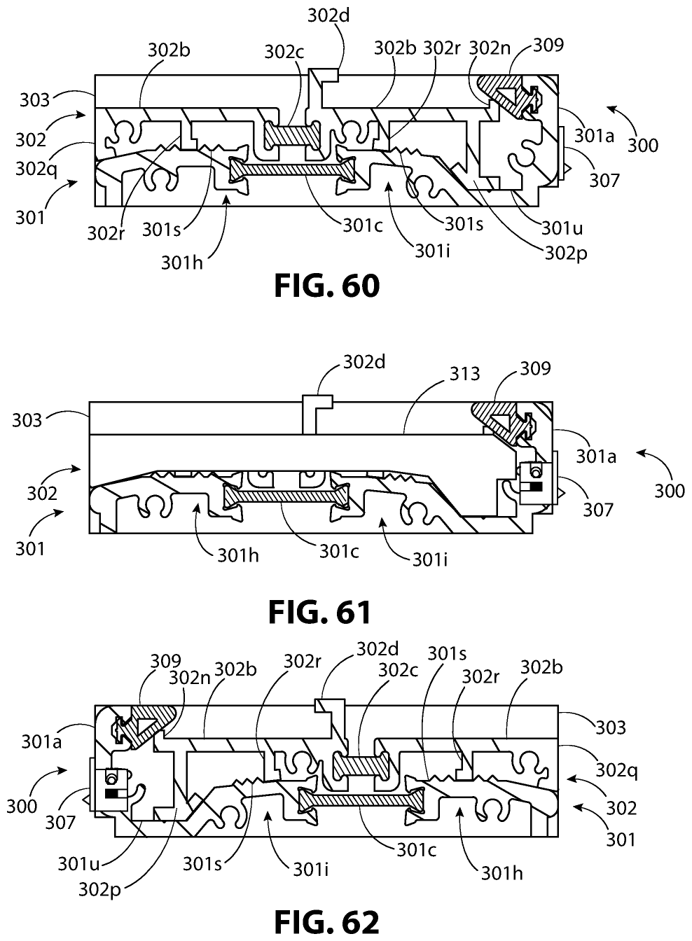

The following description is made with reference to figures where like numerals refer to like elements. FIGS. 1-13, 70, and 71 illustrate a first example of a sill assembly 100 for an outswing door. FIGS. 14-32 illustrate a second example of a sill assembly 200 for an outswing door. FIGS. 33-43, and 68 illustrate the sill assembly 200 of FIGS. 14-32 with the addition of an alignment portion for aligning and holding the vertical jambs and sidelites. FIGS. 44-56 illustrate an example of a sill assembly 300 for an inswing door. FIGS. 57-67, and 69 illustrate the sill assembly 300 of FIGS. 44-56 with the addition of an alignment portion for aligning and holding the vertical jambs and sidelites.

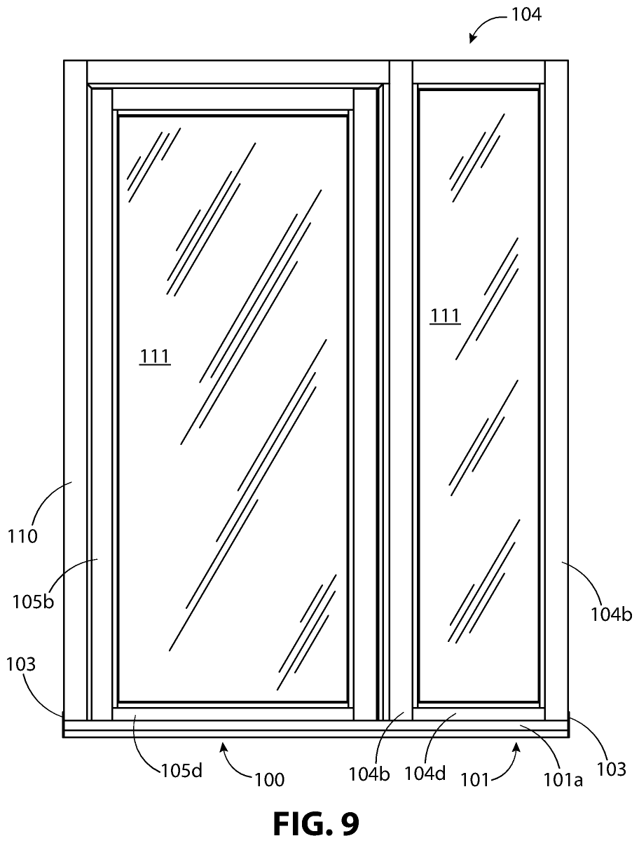

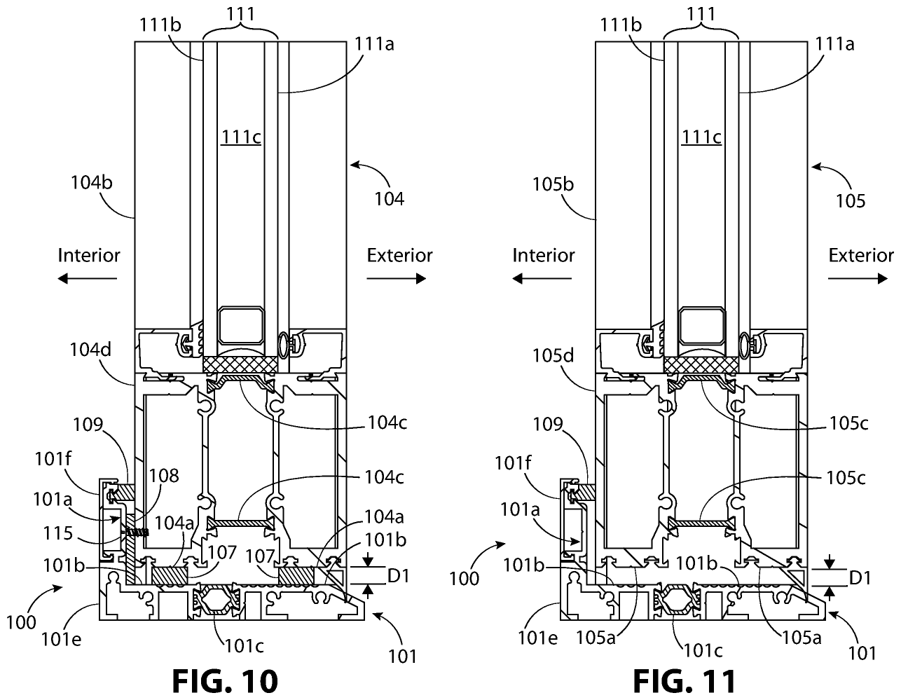

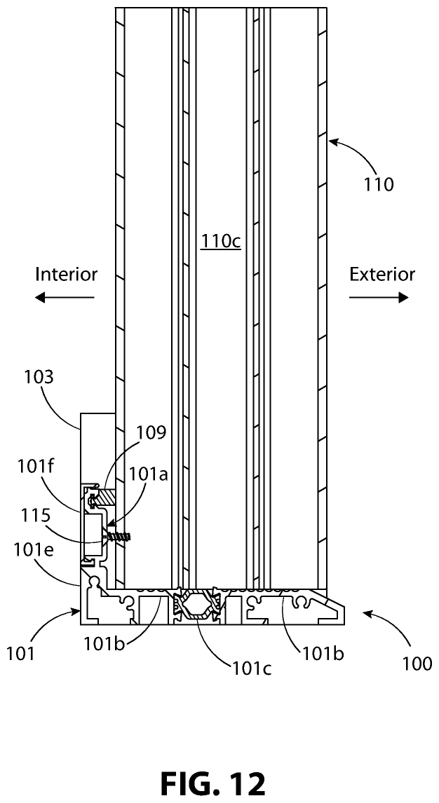

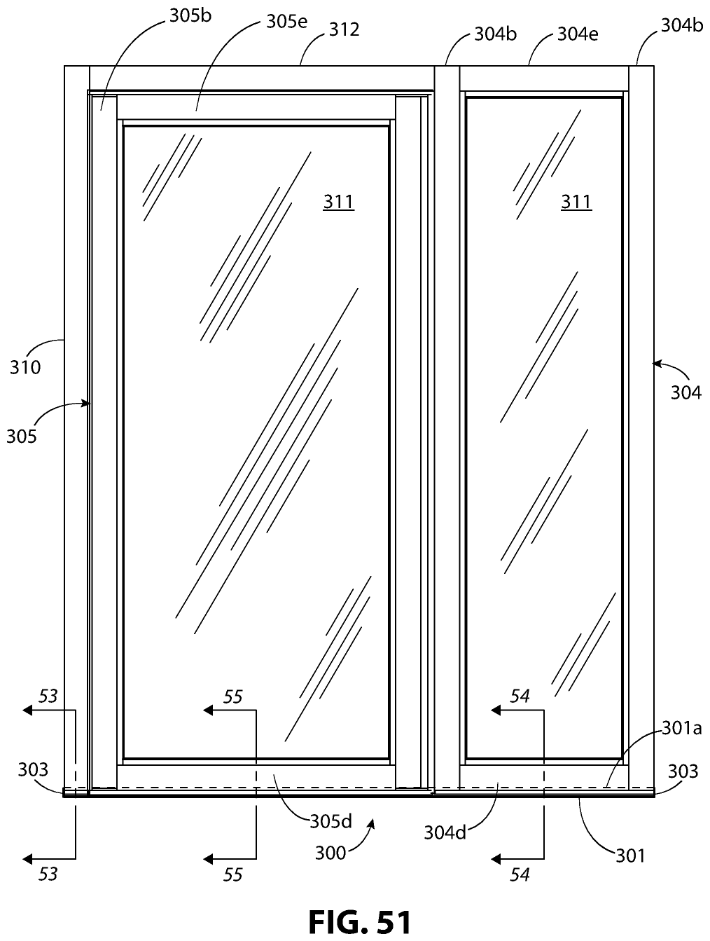

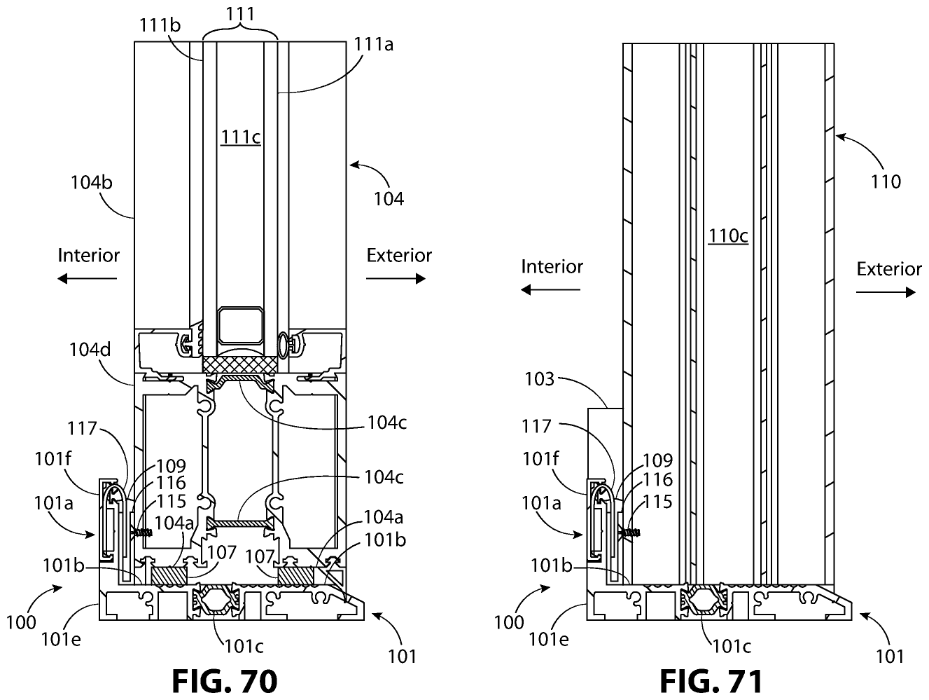

The sill assembly 100 (FIGS. 1-13, 70, and 71), sill assembly 200 (FIGS. 14-43, and 68), and sill assembly 300 (FIGS. 44-67, and 69) have common features and advantages. First, the sill body 101 (FIGS. 1-13, 70, and 71), sill body 201 (FIGS. 14-43, and 68), and sill body 301 (FIGS. 44-67, and 69) all include backstops; sill backstop 101a (FIGS. 1-12, 70, and 71), sill backstop 201a (FIGS. 14-43, and 68), and sill backstop 301a (FIGS. 44-67, and 69). The sill backstop 101a, 201a, and 301a aligns the door in the closed position, in the same vertical plane as the sidelites. The sill backstop 101a, 201a, 301a prevents air and water infiltration by creating a vertical seal against the door and sidelites. Second, the sill assemblies 100, 200, 300 include a series of horizontal surfaces 101b (FIGS. 1-6 and 10-12, 70, and 71), horizontal surfaces 202b (FIGS. 14-17, 19, 20, 24, 25, 29, 30, 33-37, 39, 42, 43, and 68), horizontal surfaces 302b (FIGS. 44-47, 49, 50, 53, 54, 57-60, 62, and 63, 65, 66, and 69), respectively, disposed across the length of the sill body 101, 201, 301, respectively, for receiving the door, sidelites, vertical jambs, and mull posts. For the sill assembly 100, the horizontal surfaces 101b are located on the sill body 101. For sill assemblies 200, 300, the horizontal surfaces 202b, 302b, respectively, are located on sill decks 202 (FIGS. 14-20, 23-25, 29, 30, 33-39, 41-43, and 68) and sill decks 302 (FIGS. 44-50, 53-55, 57-63, 65-67, and 69), respectively. Third, the sill body 101, 201, 301 in combination with end dam 103 (FIGS.1, 2, 4, 7-9, 13, and 71), end dam 203 (FIGS. 14-16, 21, 22, and 26-35), and end dam 303 (FIGS. 44-46, 51, 52, and 56-59), respectively, are shaped and structured to shed water away from the building. This can create a watertight barrier with respect to surrounding wall structure, allow for the possibility of using the sill body 101, 201, 301 as its own sill deck, and potentially eliminates the need for additional flashing. Fourth, the sill assembly 100, 200, 300 can optionally include thermal breaks. The thermal breaks illustrated include thermal break 101c (FIGS. 1-6, 10-12, 70, and 71), thermal break 201c (FIGS. 14-20, 23-25, 29, 30, 33-43, and 68), and thermal break 301c (FIGS. 44-50, 53-55, 57-67, and 69), respectively. With the aid of the sill backstop 101a, 201a, 301a, the thermal breaks 101c, 201c, 301c in sill assemblies 100, 200, 300 can be aligned over thermal breaks in the doors (thermal break 105c of FIG. 11), sidelites (thermal break 104c of FIGS. 10 and 70), and the thermal breaks in the vertical jambs (thermal break 110c of FIGS. 12 and 71). Aligning the thermal breaks can significantly improve the thermal efficiency of the doorway assembly by reducing heat transfer between the inside and outside of the doorway structure. Fifth, sill assemblies 100, 200, 300 are structured so sidelite 104 (FIG. 8), sidelite 204 (FIG. 21), and sidelite 304 (FIG. 51), can be aligned along the bottom vertical edge with their respective door, door 105 (FIG. 8), door 205 (FIG. 21), and door 305 (FIG. 51). This can help the doorway have a more uniform visual impression.

Now, looking at each of the sill assemblies in detail, we turn to the sill assembly 100 of FIGS. 1-13. Referring to FIGS. 1-4, 6, 10, and 70, spacers 107 can be placed on the horizontal surfaces 101b to space the bottom of the sidelite 104 (FIGS. 10 and 70) above the sill body 101 and even with the bottom of the door 105 of FIG. 11. Referring to FIG. 10, the spacers 107 lift the bottom surface 104a of the sidelite 104 a distance D1. Referring to FIG. 11, D1 represents the clearance between the bottom surface 105a of the door 105 and the horizontal surface 101b of the sill body 101. Referring to FIG. 10, the spacers 107 are cushioning members made of material with elastic properties, that are capable of supporting the sidelites 104. Examples of appropriate materials for the spacers 107 include ethylene propylene diene monomer (EDPM), polychloroprene (i.e., neoprene), rubber, silicone, or other materials with similar elastic properties that are capable of supporting the sidelites 104.

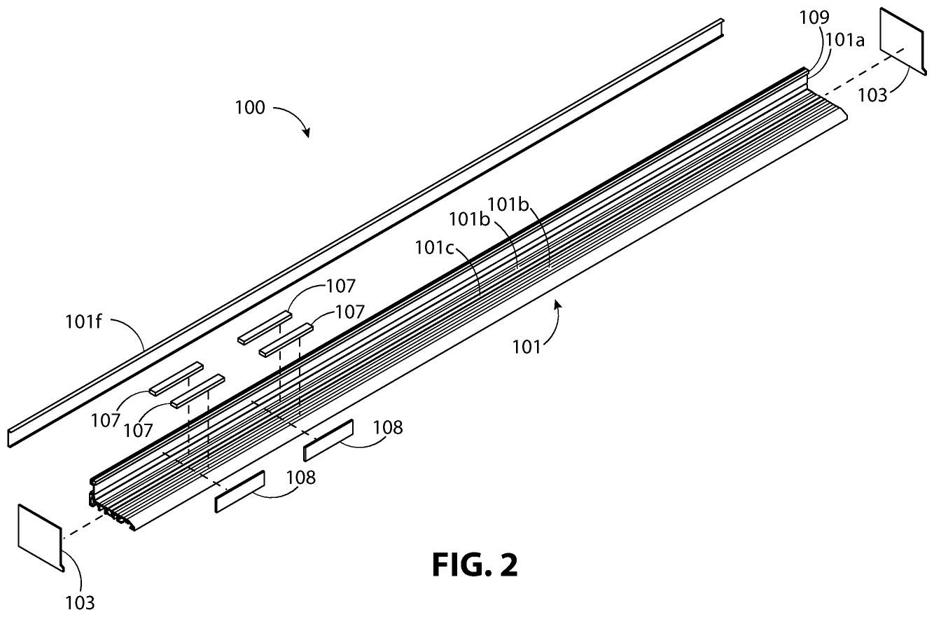

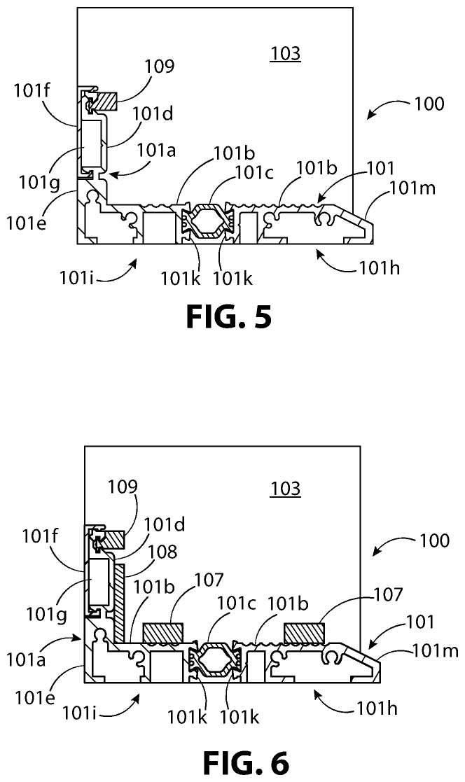

Referring to FIGS. 5 and 6, the sill backstop 101a projects directly up from the rear-most of the horizontal surfaces 101b. The inward-facing surface 101d of the sill backstop 101a is approximately perpendicular to the horizontal surfaces 101b. Referring to FIGS. 5 and 6, and 10-12, the back surface 101e (i.e., the outward-facing surface) of the sill backstop 101a, defines the back surface and lengthwise back edge of the sill body 101 and can project approximately perpendicular to the horizontal plane of the sill assembly 100. Referring to FIGS. 2, 3, 5, 6, 10, 11, 12, the sill backstop 101a can optionally include a cover plate 101f. Referring to FIGS. 5 and 6, the cover plate 101f can function as decorative trim or can cover a cavity 101g that can be used to route wires.

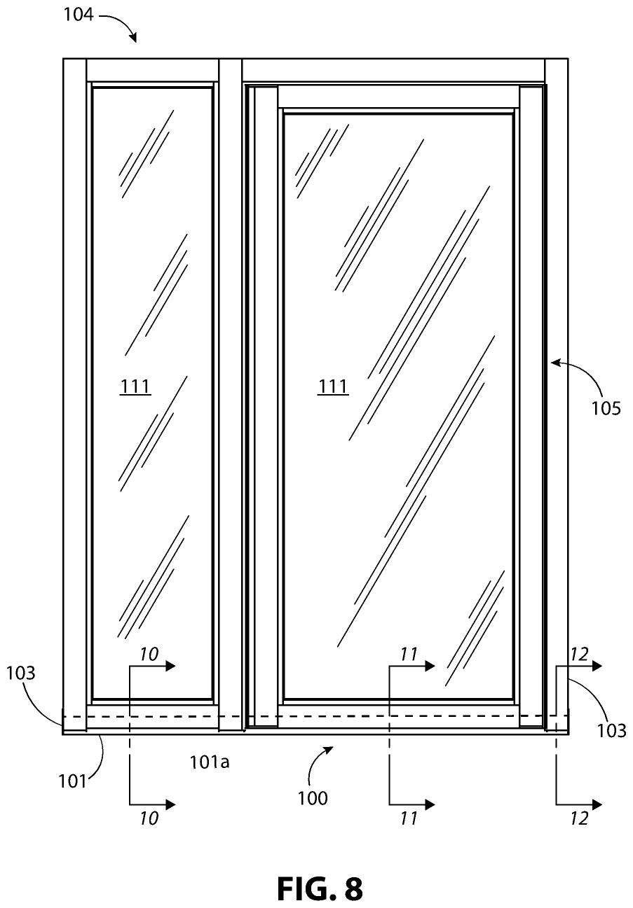

Referring to FIGS. 1-3, 6, and 10, spacer block 108 spaces the sidelite 104 (FIG. 10) a distance away from the sill backstop 101a. Seal 109 creates an air-tight seal and watertight seal between inward-facing surface 101d of the sill backstop 101a and the sidelite 104. Seal 109 is typically silicone sealant, other watertight sealants, or sealant tape. Referring to FIGS. 70 and 71, the seal is illustrated as silicone sealant. Referring to FIGS. 1-6, 10-12, 70, and 71, the seal 109 can run either continuously, or in sections, across the sill backstop 101a in its entirety. This allows the seal 109 to create an air seal across the sidelite 104 (FIGS. 10 and 70), the door 105 (FIG. 11), and the vertical jamb 110 (FIGS. 12 and 71). Referring to FIGS. 9-12, 70, and 71, the rear surfaces of the sidelite stiles 104b (FIGS. 9, 10, and 70) and sidelite bottom rail 104d (FIGS. 9, 10, and 70), the door stiles 105b and door bottom rail 105d (FIGS. 9 and 11), and the vertical jamb 110 (FIGS. 9, 12, and 71) are all aligned against the sill backstop 101a in the same plane. If the sidelite stiles 104b, sidelite bottom rail 104d, door stiles 105b, door bottom rail 105d, and the vertical jamb 110 are all the same thickness, then their front surfaces would also lie in the same plane, which could be aesthetically desirable. Referring to FIGS. 10, 12, the sidelite 104 (FIG. 10) and the vertical jamb 110 (FIG. 12) can be optionally secured to the sill backstop 101a by a threaded fastener 115. The threaded fastener can be a screw, bolt or any other threaded fastener capable of securing the sidelite 104 and the vertical jamb 110 to the sill backstop 101a. The thread fastener can optionally be covered by the cover plate 101f.

Referring to FIGS. 70 and 71, the sidelite 104 (FIG. 70) and the vertical jamb 110 (FIG. 71) can optional be secured to the sill backstop 101a by a combination, threaded fastener 115, a bracket 116, and spring clip 117. The bracket 116 rests against the rearward most of the horizontal surfaces 101b and between either the sill backstop 101a and the sidelite 104 (FIG. 70) or the sill backstop 101a and the vertical jamb 110. The threaded fastener 115 secures the bracket 116 to the sidelite 104 (FIG. 70) or the vertical jamb (FIG. 71). The spring clip 117 straddles the opposite side of the bracket 116 and the sill backstop 101a, securing the bracket 116 to the sill backstop 101a by spring tension. The spring clip 117 can optionally be embedded within the seal 109, for example silicone or structural silicone. The bracket is illustrated as u-shaped, and the sill backstop 101a has been simplified for illustrative purposes. The sill backstop can be shaped as in FIG. 10 with the bracket 116 shaped to accommodate the still backstop. Alternatively, the bracket 116 can be any shaped that allows it act as an intermediary to join the sill backstop 101a to either the sidelite 104 (FIG. 70) or the vertical jamb 110 (FIG. 71). While this arrangement has more parts and is more complex than simply using a threaded fastener 115 as in FIGS. 10 and 12, it can be used to prevent leakage between sidelite 104 (FIG. 70) and the sill backstop 101a or the vertical jamb 110 (FIG. 71) and the sill backstop 101a by not having the threaded fastener penetrate the sill backstop 101a.

Referring to FIGS. 5 and 6, the sill body 101 can be extruded from aluminum. The sill backstop 101a is integrally formed with the remainder of the sill body 101. For a thermally broken sill, such as those shown throughout this disclosure, the sill can alternatively be extruded in two parts: A front sill body 101h and a rear sill body 101i. The sill backstop 101a being integral with the rear sill body 101i and projecting vertically upward. The front sill body 101h includes a front portion 101m that slopes downward from the horizontal surface 101b of the front sill body 101h. The front sill body 101h and the rear sill body 101i are shown joined by the thermal break 101c. Referring to FIGS. 10-12, 70, and 71, the thermal break 101c in the sill body 101, as well as the thermal breaks 104c in sidelite 104 (FIGS. 10 and 70), the thermal breaks 105c in the door 105 (FIG. 11), and the thermal break 110c in the vertical jamb 110 (FIGS. 12 and 71) are made of thermally insulative material such as polyamide and are illustrated in the form of a thermal strut. Throughout this description, a thermal break can be a thermal strut or can alternatively be made of other thermally insulating materials capable of rigidly joining and thermally isolating the exterior-facing portion and interior-facing portion of the various structures described throughout this disclosure. By rigidly joining, we mean joining the structures in such a way so they form a rigid body that acts as a unit and withstands load bearing and other forces from typical use. Referring to FIGS. 5 and 6, the thermal breaks 101c can be crimped into grooves 101k in the front sill body 101h and the rear sill body 101i by large crimping rollers. Crimping in this way can provide a watertight seal across the front sill body 101h and the rear sill body 101i. Silicone or other waterproof sealant can be placed along the lengthwise seams of the thermal break 101c to enhance water tightness. The sill with sill backstop 101a integral with the rear sill body 101i, thermal breaks 101c, end dams 103, horizontal surfaces 101b, and front portion 101m, structured as described, lends the sill assembly 100 to act as both door threshold and sill pan as this combination can create watertight barrier with respect to the surrounding wall opening. This can potentially reduce parts count and simplify assembly.

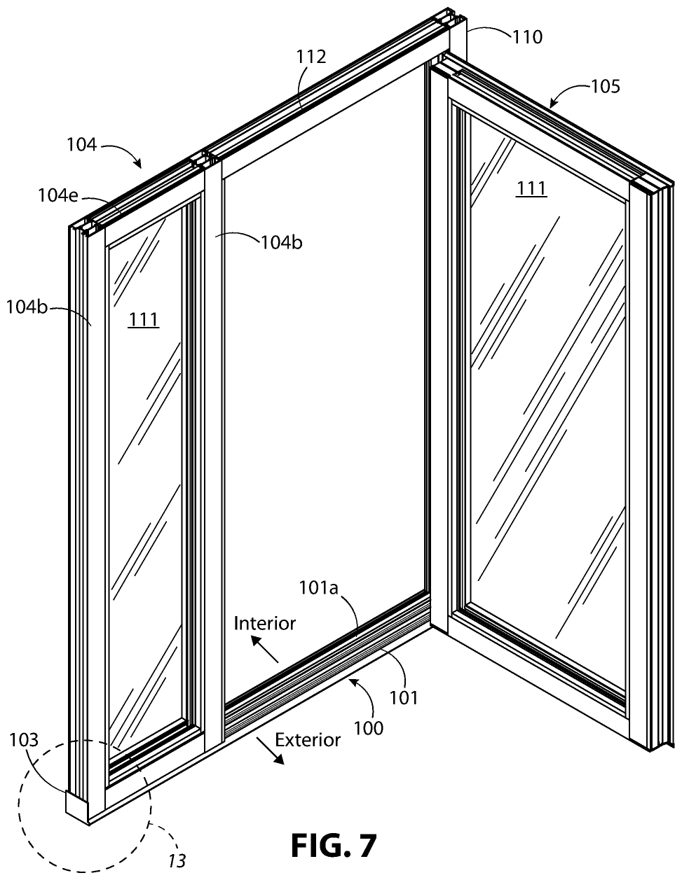

Referring to FIGS. 10-12, 70, and 71, the thermal breaks of the sill body 101, sidelite 104, door 105, and vertical jamb 110 are aligned so that inside-facing section of sill body 101, sidelite 104, door 105, and vertical jamb 110 are thermally isolated. Referring to FIGS. 7-11 and 70, this includes the glazing panels 111 which are illustrated as insulating glass units (IGU). Referring to FIGS. 10 and 11, the glazing panels 111 can include a first glass panel 111a and a second glass panel 111b separated by a cavity 111c filled with either air or gas. Referring to FIGS. 10-12, 70, and 71, the thermal breaks are aligned but not centered. Referring to FIGS. 5 and 6, the width of the front sill body 101h and rear sill body 101i can be adjusted to align the thermal breaks in FIGS. 10-12, 70, and 71.

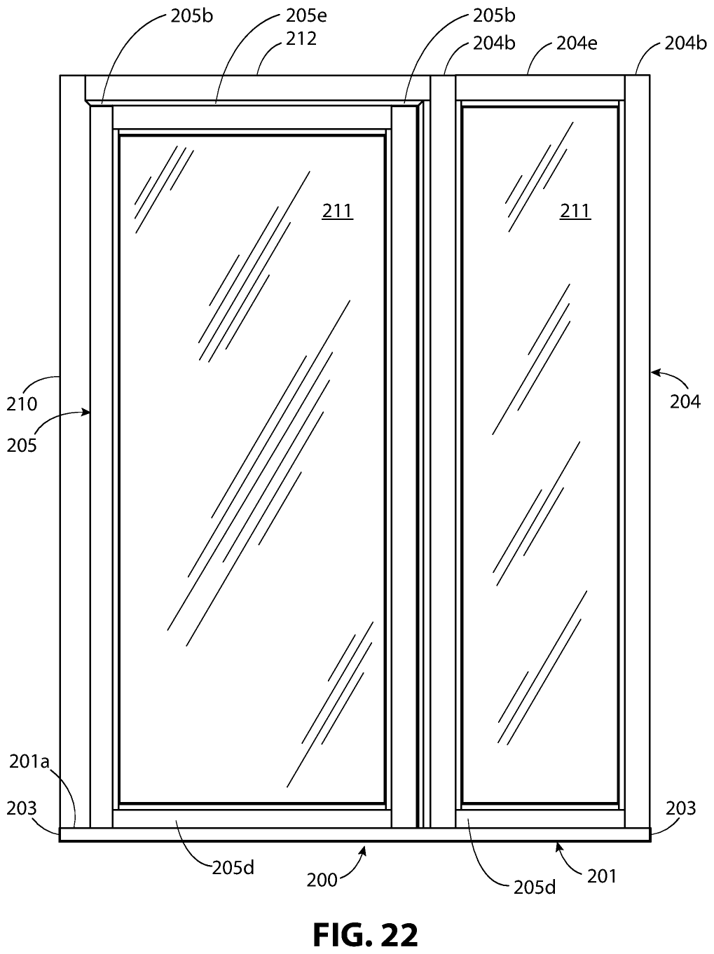

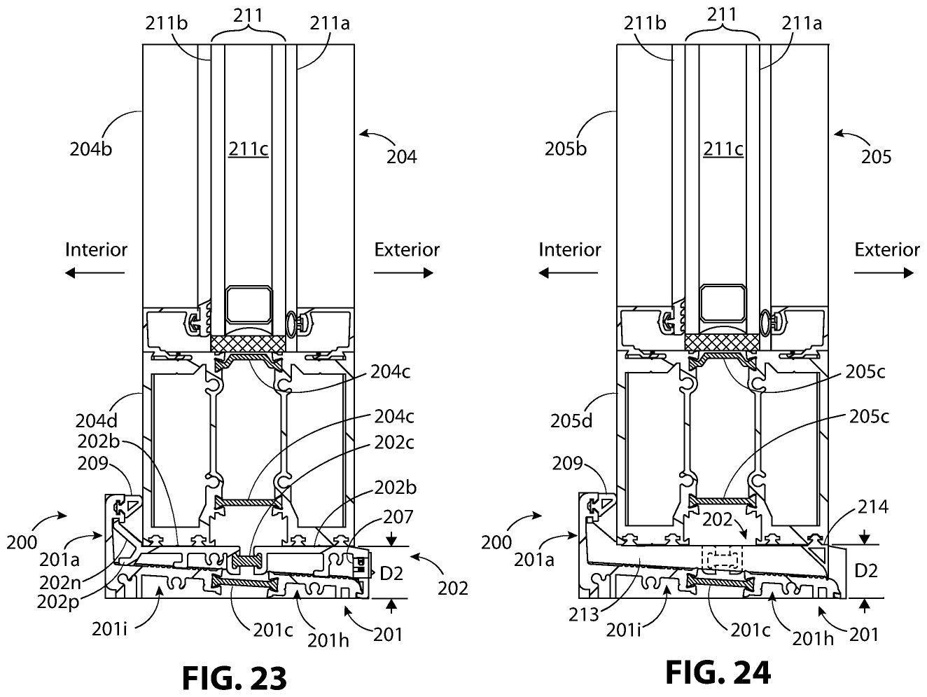

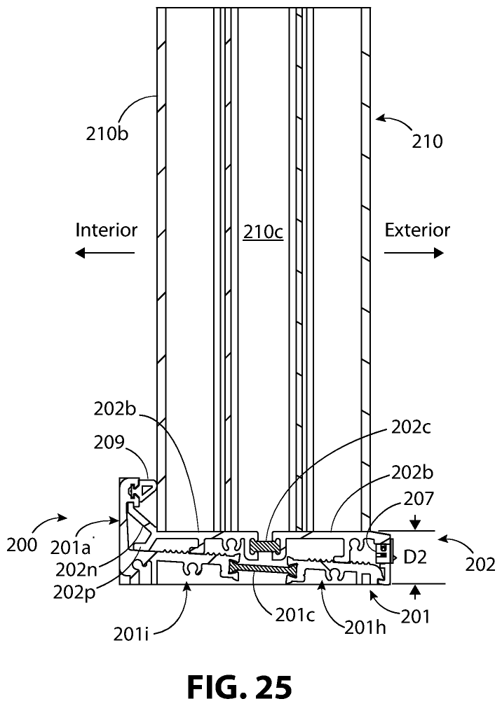

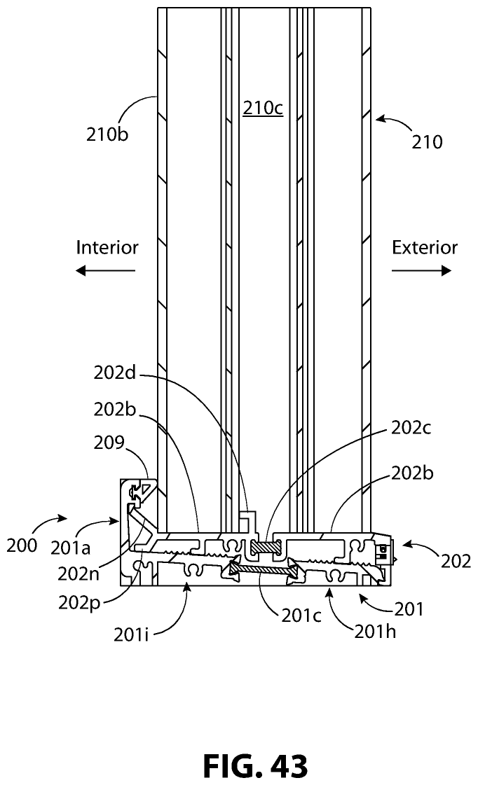

FIGS. 14-43, and 68 illustrate a second example of a continuous sill for use with an outswing door and one or more sidelites. The sill assembly 200 of FIGS. 33-43, and 68 includes alignment portions 202d (shown in FIGS. 33-39, 42, 43, and 68) for aligning and securing sidelites and vertical jambs. The sill assemblies 200 of FIGS. 14-32 do not include alignment portions. Referring to FIGS. 14-20, 23-25, 29, 30, 33-39, and 41-43, and 68, the sill assembly 200 includes two main portions: The sill body 201 and one or more of the sill decks 202. The sill decks 202 are illustrated extending from the back of the sill body 201 to the front lengthwise edge of the sill body. The sill body 201 acts as the threshold for the door 205 (see FIGS. 24, 27, 28, 31, 32, and 41) and together with the end dams 203 (FIGS. 14-19, 21, 22, 26-38) act as the sill pan as this combination can create a watertight barrier with respect to surrounding wall structure. The sill decks 202 are mounted and secured over the sill body 201 and provide horizontal surfaces 202b for the bottom surfaces of the sidelites 204 (FIGS. 23 and 42) and the bottom surfaces of the vertical jambs 210 (FIGS. 25 and 43) to mount against. The horizontal surfaces 202b are part of the sill decks 202 and are shown in FIGS. 14-17, 19, 20, 23, 25, 29, 30, 33-37, 39, 42, 43, and 68.

Referring to FIGS. 23 and 25, the sill decks 202 raises the sidelite 204 and vertical jamb 210 a distance D2 above the floor level. Referring to FIGS. 24, 27, 28, 31, 32, and 41, the door 205 closes directly over the sill body 201. Referring to FIG. 24, the bottom of the door bottom rail 205d sits above the floor level a distance D2 allowing clearance for the door to swing. Referring to FIGS. 23-25, this arrangement aligns the bottom lengthwise edge of the sidelite bottom rail 204d (FIG. 23), the bottom lengthwise edge of the door bottom rail 205d (FIG. 24), and the bottom lengthwise edge of the vertical jamb 210 (FIG. 25). Note that the sill deck cover 213 in FIG. 24 is behind the door. The door sweep 214 provides weather sealing from the outside elements but allows accumulated water to drain out to the exterior environment.

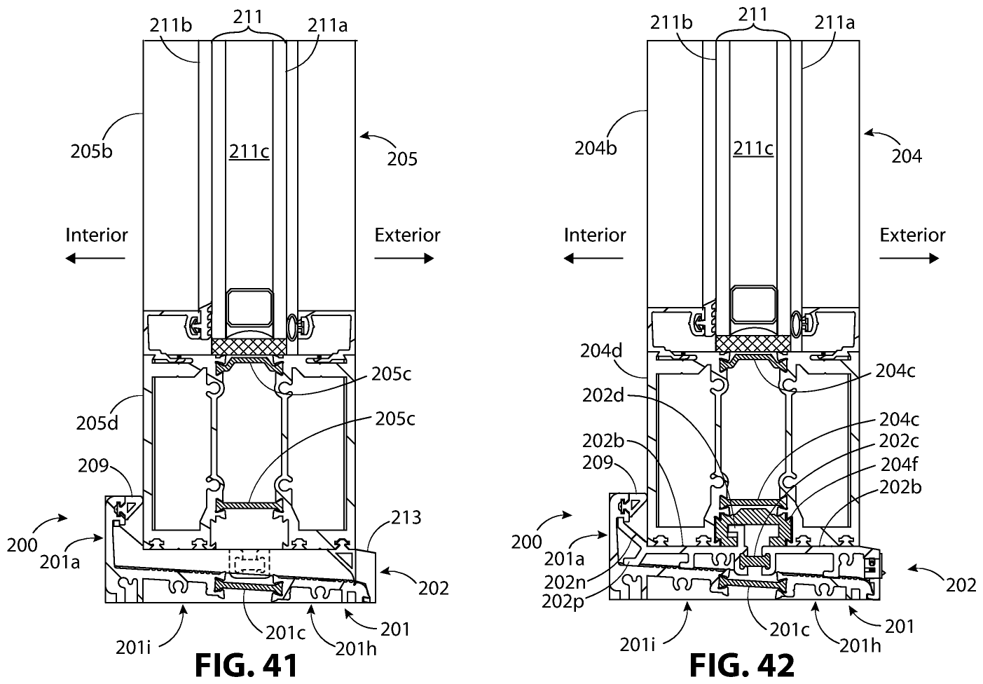

Referring to FIGS. 23, 42, and 68, the thermal breaks 201c, 202c of the sill body 201 and the sill decks 202, respectively, can align, as illustrated, under the thermal break 204c of the sidelite 204. Referring to FIGS. 25 and 43, the thermal breaks 201c, 202c of the sill body 201 and the sill decks 202, respectively, can align, as illustrated, under hollow cavity 210c between thermal breaks (not shown) of the vertical jamb 210. Referring to FIGS. 24 and 41, in the closed position, the thermal breaks 201c of the sill body 201 can be aligned, as illustrated, under the thermal breaks 205c of the door 205. By the alignment described above, the inside-facing side of the door 205, the vertical jamb 210, the sidelite 204, sill body 201, and sill decks 202 can be thermally isolated from the exterior environment. Referring to FIGS. 23, 24, 41, 42, and 68 this includes the glazing panels 211 which are illustrated as an IGU. The glazing panels 211 can include a first glass panel 211a and a second glass panel 211b separated by a cavity 211c filled with either air or gas.

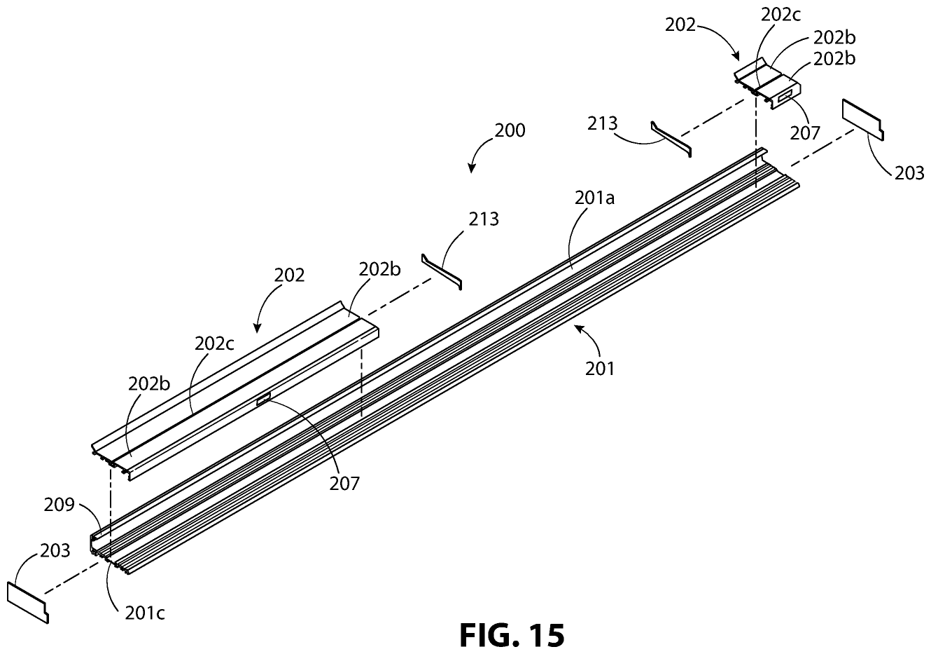

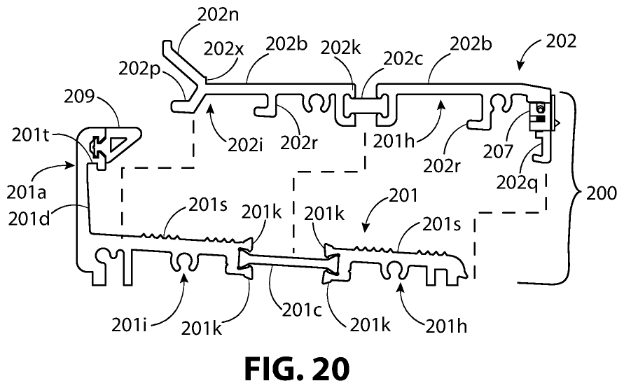

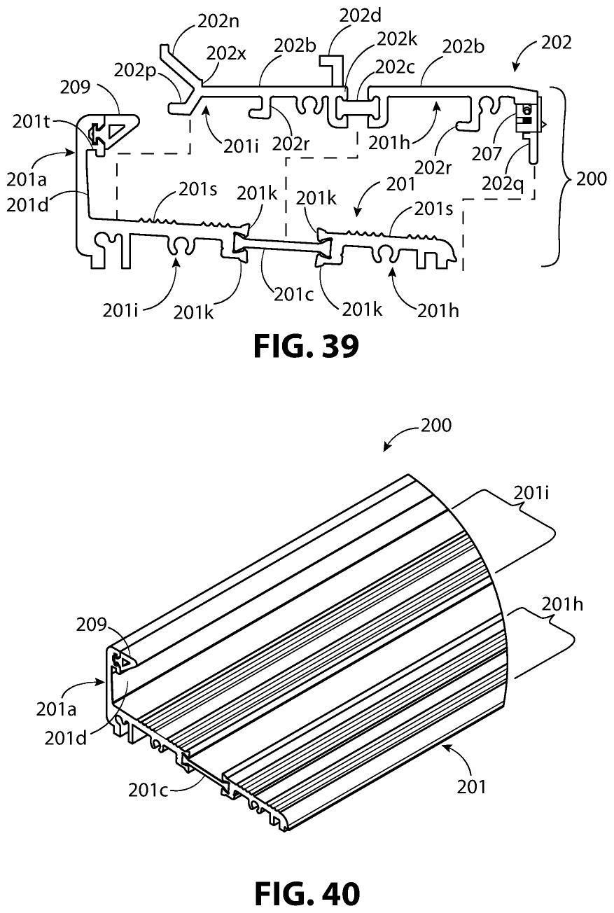

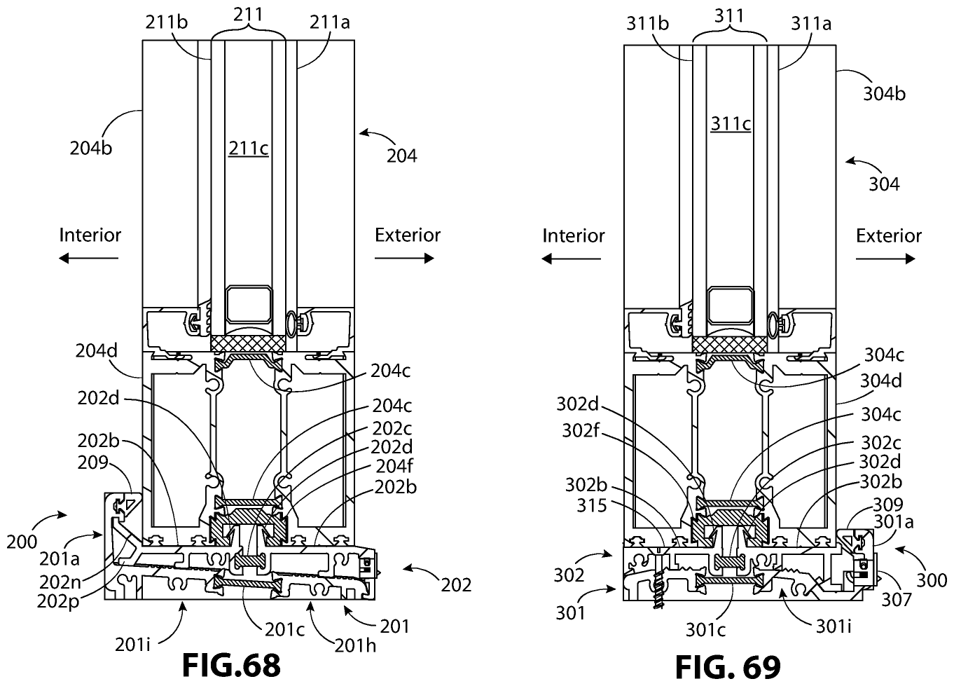

Referring to FIGS. 23, 42, and 68, gasket 209 helps to create an air-tight seal between the sill backstop 201a and the sidelite 204. Referring to FIGS. 15, 17-20, 23-25, 30, 34, 36-43, and 68, the gasket 209 can run either continuously, or in sections, across the sill backstop 201a in its entirety. This allows the gasket 209 to create an air seal across the sidelite 204 (FIGS. 23, 42 and 68), the door 205 (FIGS. 24 and 41), and the vertical jamb 210 (FIGS. 25 and 43). Referring to FIGS. 23-25, 41-43, and 68, the rear surfaces of the sidelite stiles 204b and sidelite bottom rail 204d (FIGS. 23, 42, and 68), the door stiles 205b and the door bottom rail 205d (FIGS. 24 and 41), and the vertical jamb 210 (FIGS. 25 and 43), all align in the same plane against the sill backstop 201a via the gasket 209. If the sidelite stiles 204b, sidelite bottom rail 204d, door stiles 205b, door bottom rail 205d, and the vertical jamb 210 are all the same thickness, then their front surfaces would also lie in the same plane, which could be aesthetically desirable. Referring to FIGS. 20 and 39, a notch 202x that projects perpendicularly from the horizontal surface 202b of the sill decks 202 can optionally help facilitate alignment of either the sidelite 204 of FIGS. 23 and 42 or the vertical jamb of FIGS. 25 and 43 against the sill backstop 201a so they lie in the same plane. Referring to FIGS. 42, 43, 68 the alignment portion 202d can align the sidelite 204 (FIG. 42) and the vertical jamb 210 (FIG. 43) against the sill backstop 201a in the same plane. Referring to FIGS. 42, and 68, the alignment portion 202d can also align the thermal break 202c of the sill decks 202 with the thermal breaks 204c and the cavity 211c of the glazing panels 211. Referring to FIGS. 42 and 68 the alignment portion 202d can also help secure the sidelite 204 to the sill decks 202 by a receiver 204f fitted within the sidelite 204. Here the receiver 204f is shown as a gasket fitted within a euro groove of the sidelite 204. The receiver 204f can also be integrated into the sidelite 204 (i.e. a portion of the sidelite 204). Referring to FIG. 43, while not illustrated, the vertical jamb 210 can optional include a receiver 204f, or can include an integral portion that performs the function of the receiver. For example, the vertical jamb 210 could include a euro groove. Alternatively, it could be optionally shaped to slidably receive the alignment portion 202d. Referring to FIG. 39, the alignment portion 202d can be L-shaped. The stem of the alignment portion 202d extends upward from the horizontal surface 202b of the sill decks 202. The arm of the alignment portion 202d extends directly away from the stem and toward the sill backstop 201a. In FIG. 39, the stem of the alignment portion 202d extends vertically upward from the horizontal surface 202b and the arm of the alignment portion 202d extends perpendicularly away from stem of the alignment portion 202d and horizontally toward the sill backstop 201a. The alignment portion 202d is shown as being integrally formed with the sill decks 202. However, the alignment portion 202d can be rigidly secured to the alignment portion by welding, adhesive, rivets, threaded fasteners or any other method of securing that creates a rigid bond capable of withstanding the forces encountered for a given installation. While the alignment portion 202d is shown as L shaped, it can be any shape capable of engaging the receiver 204f and aligning the sidelite 204. For example, the alignment portion 202d can be a simple upward projection where it could align the sidelite 204, allow it to slide, but would not be captively slidable as in the case of other shapes, for example an L-shaped bracket or a T-shaped bracket. The receiver 204f may optionally be shaped to captively and slidably engaging the receiver 204f (FIG. 42) or snap and lock into receiver 204f (FIG. 68), euro groove, or directly into the sidelite 204.

Referring to FIG. 68, the alignment portions 202d may optionally snap into the receiver 204f, directly into the euro groove, or directly into a receiver 204f integrated into the sidelite 204 (for example, directly into the sidelite 204 itself). The sill deck 202 includes two of the alignment portions 202d. Each of the alignment portions 202d is illustrated as barbed or hooked. The upper part is angled downward like an arrowhead and thinner than the main stem allowing it to flex. The upper portions of the alignment portions 202d project downward away from each other. This arrangement allows the sidelite 204 to be pressed downward against the receiver 202f and snap into place. As the sidelite 204 is pressed downward, the upper part of the alignment portions flex inward, allowing the alignment portions 202d to pass through the opening in the alignment portion. Once the alignment portions 202d pass through the opening and the pressure is release from the upper portions of the alignment portion 202d, the upper portions well expand out to their resting position as illustrated thereby securing the sidelite 204 to the sill deck 202.

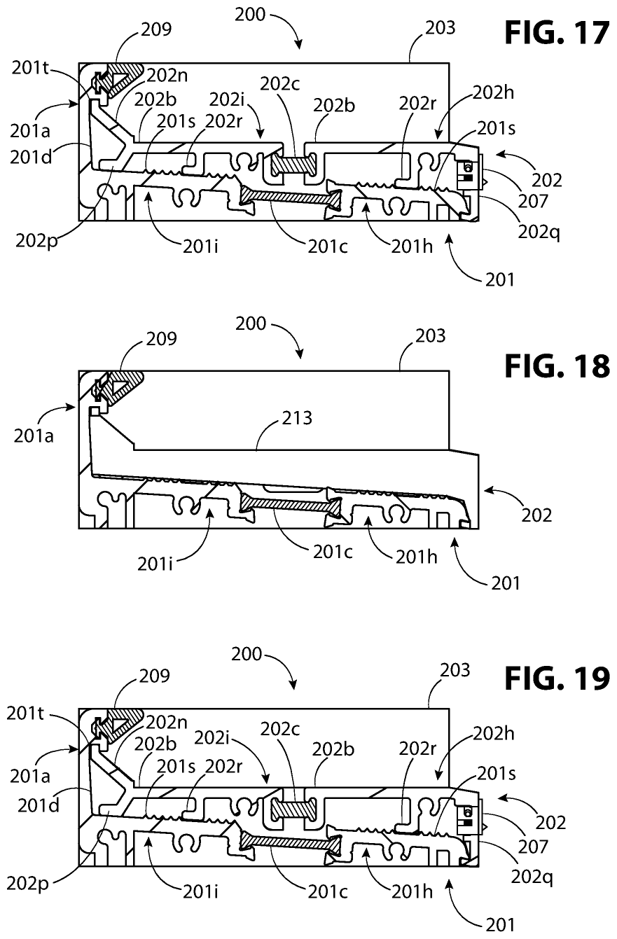

Referring to FIGS. 17, 19, 20, 23, 25, 36, 37, 39, 42, 43, and 68, the sill decks 202 mounts to the sill body 201 as follows. The sill decks 202 includes a sill deck backstop 202n projecting upwardly and obliquely away from the end of the rear sill deck portion 202i. The sill deck backstop 202n can be hooked shaped as illustrated and can include an end portion that engages a groove 201t in the sill backstop 201a by pivoting the sill deck 202 downward toward the sill body 201. The end portion is shown as projecting vertically upward, however, any angle that in combination with the groove 201t creates a captive relationship between the end portion and groove 201t is acceptable. A first mounting portion 202p projects downwardly away from the end of the rear sill deck portion 202i. The front sill deck portion 202h and the rear sill deck portion 202i, each include a mounting portion 202r that projects downward from their respective bottom surfaces. Each of the mounting portions 202r includes a foot that planarly engages the top surfaces 201s of respective front sill portion 201h and rear sill portion 201i of the sill body 201 as the sill deck 202 is rotated downward toward the sill body 201. The front surface 202q of the sill deck 202 can snap into place against the front end of the sill body 201.

Referring to FIGS. 17-20, 23-25, 36-39, 40-43, and 68, the sill body 201 can include a front sill portion 201h and a rear sill portion 201i joined together by a thermal break 201c. The thermal break thermally isolates the front sill portion 201h from the rear sill portion 201i. The thermal break illustrated is in the form of a thermal strut and made of a thermally insulative material such as polyamide. Thermal struts can typically be crimped into place by large crimping rollers. The thermal breaks 201c can be crimped into grooves 201k (FIGS. 20 and 39) in the front sill portion 201h and the rear sill portion 201i as previously described. This can create a watertight seal across the front sill portion 201h and the rear sill portion 201i. Silicone or other waterproof sealant can be placed along the lengthwise seams of the thermal break 201c to enhance water tightness. The sill backstop 201a extends directly upward from the rear sill portion 201i of the sill body 201 and defines the back portion of the sill body 201. The rear sill portion 201i and the sill backstop 201a are integral and have a unibody construction. Typically, this is accomplished by extrusion for a sill body made of aluminum. The unibody construction assures that the inward-facing surface 201d (FIGS. 17, 19, 20, 36, 37, 39, and 40) of the sill backstop 201a in combination with the rear sill portion 201i are sealed and waterproof. In combination with the end dams 203 (FIGS. 17-19 and 36-38), provides a watertight seal and allows the sill body 201 to act both as a door sill and a sill pan.

Referring to FIGS. 14-17, 19, 20, 23, 25, 29, 30, and 33-39, the thermal breaks 202c thermally break the sill decks 202 between the front sill deck portion 202h and the rear sill deck portion 202i. The front sill deck portion 202h and the rear sill deck portion 202i are shown in FIGS. 17, 19, 20, 36, 37, and 39. Referring to FIGS. 20 and 39, the thermal break 202c can be crimped into grooves 202k in the front sill deck portion 202h and the rear sill deck portion 202i by large crimping rollers as previously described creating a watertight seal across the front sill deck portion 202h and the rear sill deck portion 202i. As previously described, silicone or other waterproof sealant can be placed also the lengthwise seams of the thermal break 202c to enhance water tightness.

Referring to FIGS. 15, 18, 24, 30, 34, 38, and 41, sill deck covers 213 are attached to the sides of the sill decks 202. The sill deck covers 213 face the door openings and create a finished appearance for the side of the sill assembly 200. The sill deck covers 213 also contain any water run-off from the top of the sill decks 202 to within the sill body 201 under the sill decks 202. Referring to FIGS. 23, 25, 42, 43, and 68, the sidelites 204 (FIGS. 23, 42, and 68) and the vertical jamb 210 (FIGS. 25 and 43) can be placed directly on the horizontal surfaces 202b of their respective 202 sill decks. They can also be placed with waterproofing silicone or a water-resistant gasket which would reduce the risk of water infiltration onto the sill decks 202. Referring to FIGS. 14, 15, 17, 19, 20, 23, 25, 29, 33, 34, 36, 37, and 39, a weep flap 207, or alternatively a weep hole, can optionally be positioned through the front surface 202q (FIGS. 17, 19, 20, 36, 37, and 39) of the sill decks 202. Referring to FIGS. 17, 19, 20, 36, 37, and 39, the top surfaces 201s of the sill body 201 are angled downward toward the front of the sill body 201. Any water that might accumulate on the sill decks 202 and leak through to the sill body 201 would tend to flow to the front of the sill body 201 and drain out the weep flaps 207.

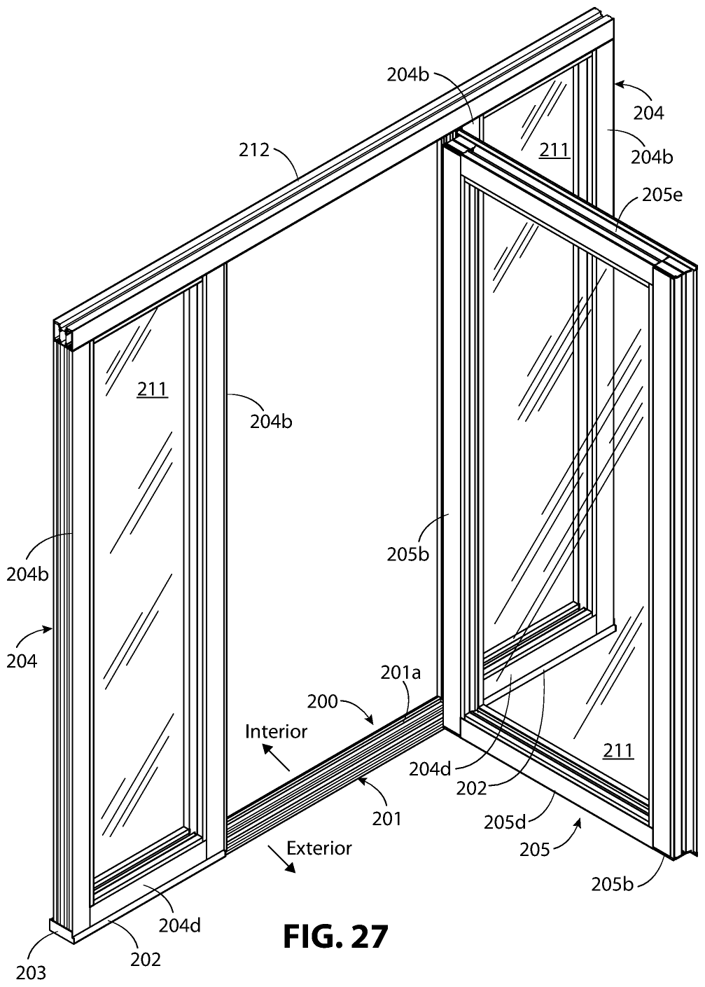

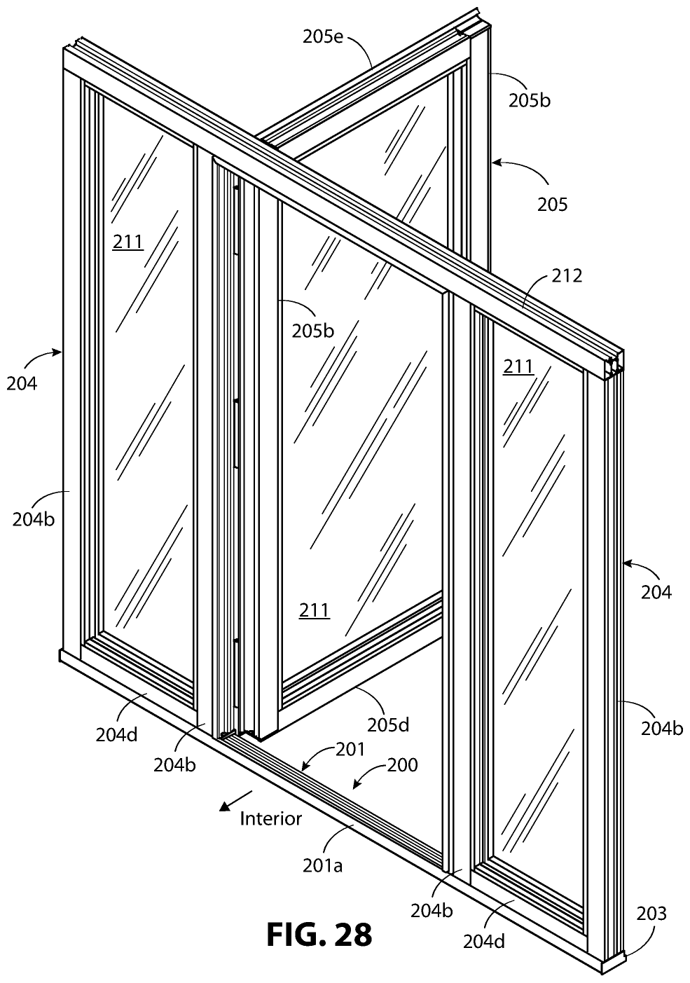

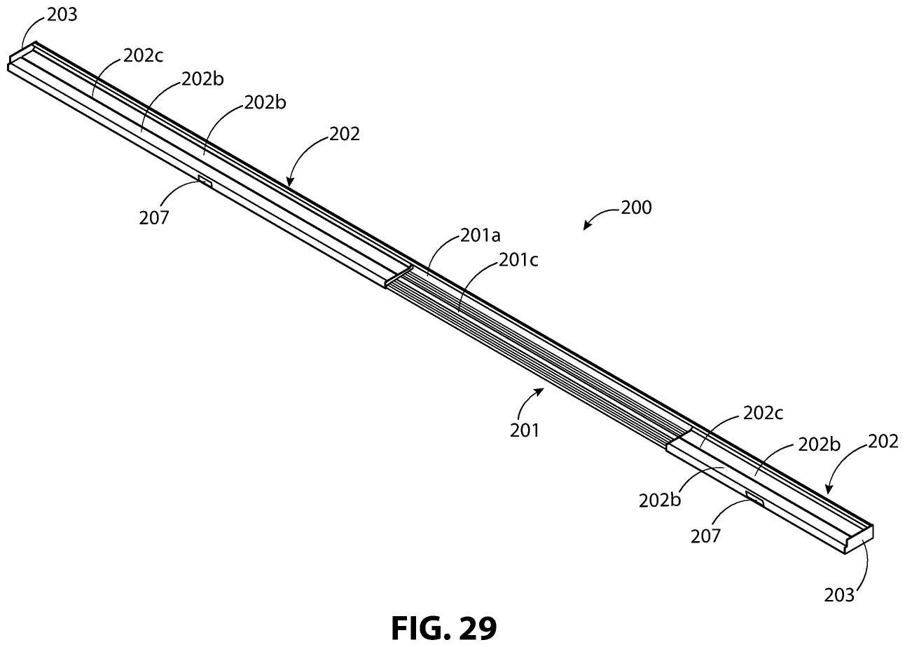

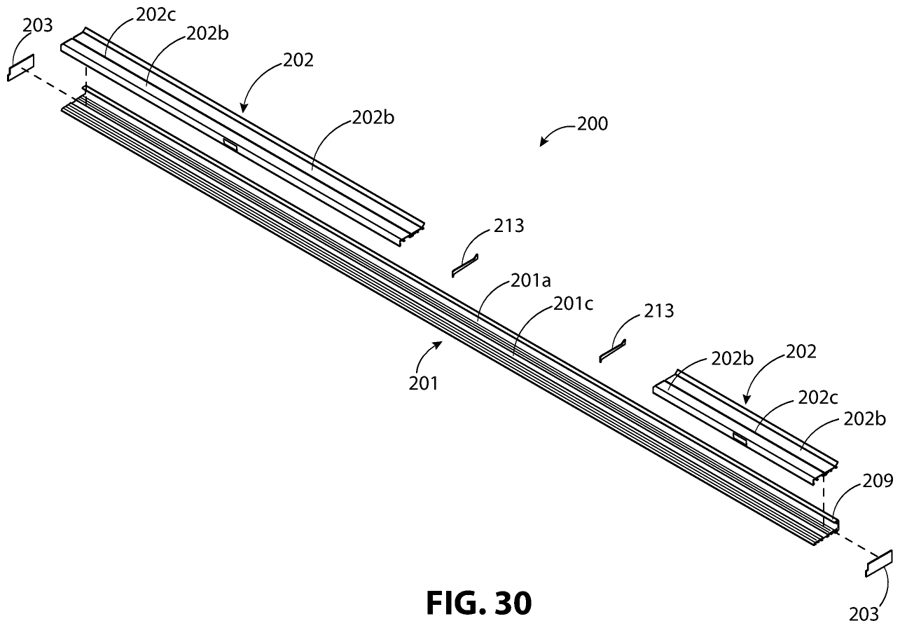

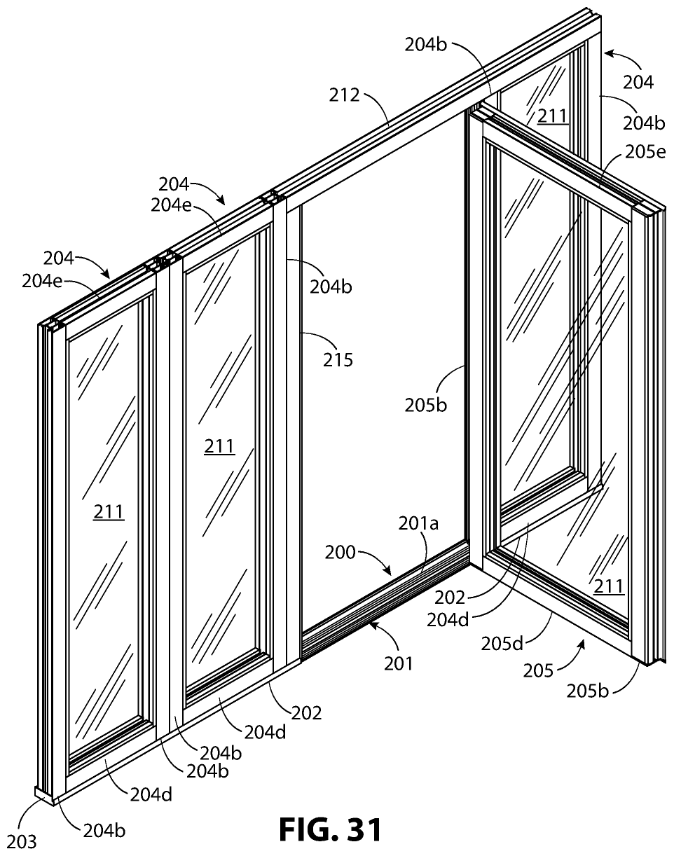

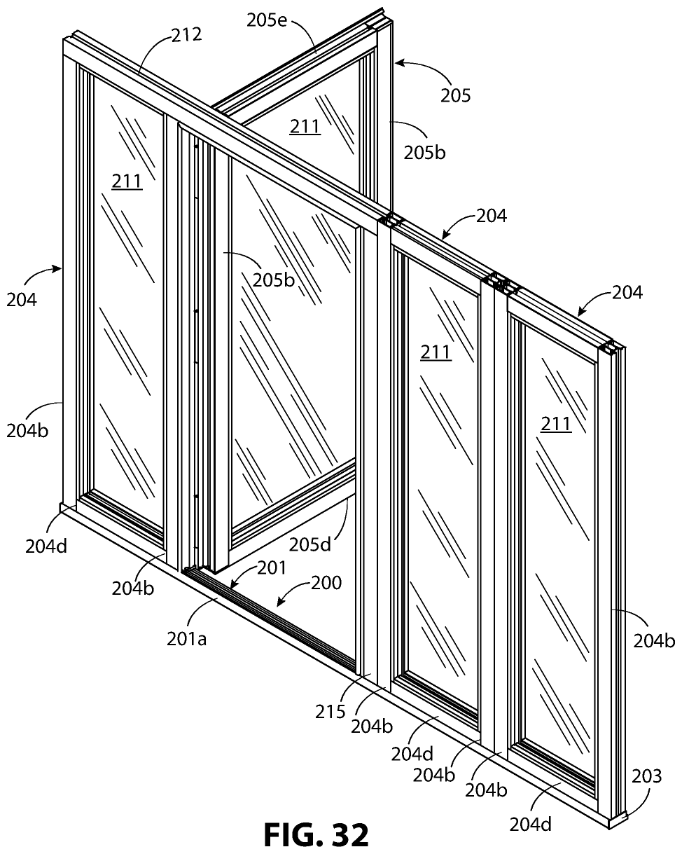

One of the advantages of the sill assemblies, such as sill assembly 100 of FIGS. 1-13, sill assembly 200 of FIGS. 14-43, and 68, and sill assembly 300 of FIGS. 44-67, and 69, is that they can be adapted to a wide range of door openings. For example, FIG. 7 shows a door passage with one of the sidelites 104 mounted to the left side of the door opening using sill assembly 100. FIGS. 27 and 28 show front and rear perspective views, respectively, of a door opening with one of the sidelites 204 mounted on either side of the door using sill assembly 200. FIGS. 31 and 32 show front and rear perspective views, respectively, of a door opening with one of the sidelites 204 on the right side of the door and with two of the sidelites 204 on the left side of the door using sill assembly 200. The corresponding sill assembly 200 for FIGS. 31 and 32 is shown in perspective view in FIG. 29 and exploded perspective view in FIG. 30.

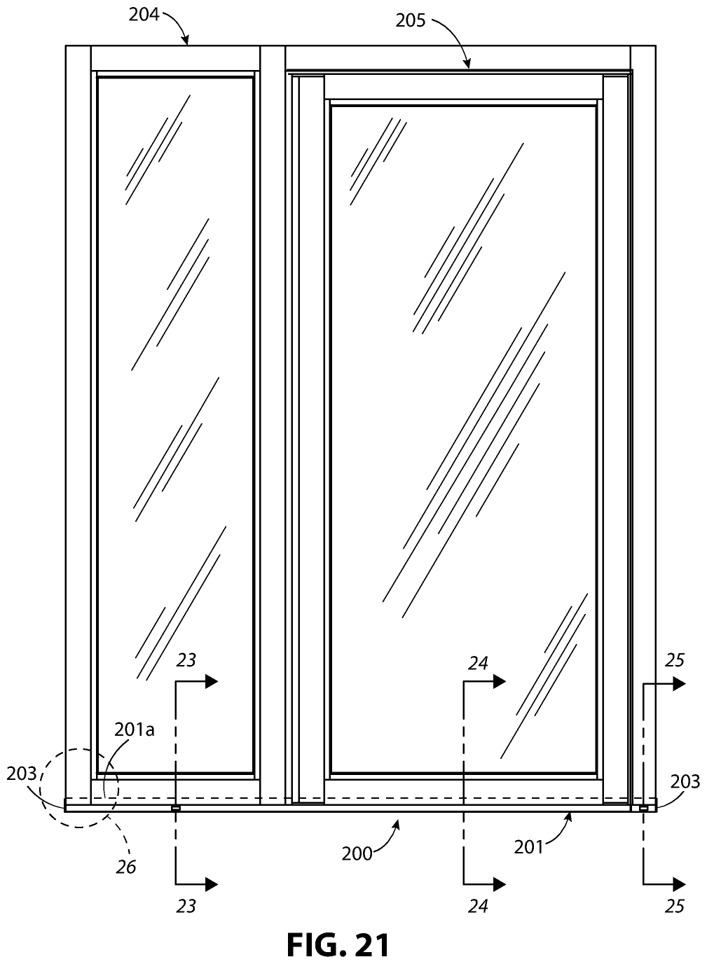

FIG. 7 shows an example of a “stick-built” doorframe. Instead of a continuous header, as in FIGS. 27 and 28, the top of the frame of the doorway is defined by the sidelite top rail 104e, the top of the sidelite stile104b, a header 112 directly above the door 105, and the top of the vertical jamb 110. The doorframe of FIGS. 21 and 22 is similarly built as the doorframe of FIG. 7. Referring to FIG. 22, the top of the frame of the doorway includes the sidelite top rail 204e, header 212, sidelite stiles 204b, and the vertical jamb 210. Glazing panel 211 of the door 205 is surrounded on either side by door stiles 205b, on the top by door top rail 205e, and on the bottom by door bottom rail 205d. Glazing panel 211 of the sidelite 204 is surrounded on the either side by sidelite stiles 204b, on the top by sidelite top rail 204e, and on the bottom by sidelite bottom rail 204d.

FIGS. 27 and 28 shows the door opening being defined by sidelite stiles 204b directly surrounding the door 205. The outermost of the sidelite stiles 204b on the outward-facing sides of the glazing panels 211 define the outside of the frame of the door opening and there is no need for separate vertical jambs. A header 212 spans the length of the entire door opening and is supported by the sidelite stiles 204b of the sidelites 204. The header 212 frames the top of the glazing panels 211 of the sidelites 204 while the sidelite bottom rails 204d frame the bottom of the glazing panels 211. The glazing panel 211 of the door 205 is surrounded on the top by a door top rail 205e, on the bottom by a door bottom rail 205d, and on the sides by door stiles 205b. When closed, the door stiles 205b and the door bottom rail 205d engage the sill backstop 201a. Referring to FIG. 27, the bottom of the sidelite stiles 204b and the sidelite bottom rail 204d are supported by the sill decks 202.

FIGS. 31 and 32 shows a doorway that includes the door opening and a sidelite 204 on right-hand side of the door opening. The door opening and the sidelite 204 are under a header 212 and are supported by a mull post 215 and the sidelite stiles 204b. The glazing panel 211 of the sidelite 204 is surrounded by the header 212 on the top, and the sidelite bottom rail 204d on the bottom, and the sidelite stiles 204b on either side. The door opening is defined by the mull post 215 on the left and the sidelite stile 204b on the right. To the left of the mull post 215, the top of the sidelite stiles 204b and the sidelite top rail 204e act as their own header. The glazing panels on the sidelites 204 are surrounded by the sidelite top rail 204e on the top, the sidelite bottom rail 204d on the bottom, and the sidelite stiles 204b on the vertical edges. The glazing panel 211 of the door 205 is surrounded on the top by a door top rail 205e, on the bottom by a door bottom rail 205d, and on the sides by door stiles 205b. When closed, the door stiles 205b and the door bottom rail 205d engage the sill backstop 201a. Referring to FIG. 31, the bottom of the sidelite stiles 204b, the mull post 215, and the sidelite bottom rail 204d are supported by the sill decks 202.

The construction of the sill assemblies 100, 200, 300 illustrated in FIGS. 1-13, 14-43, and 44-67, respectively can all be adapted to any of the configurations shown, as well as various other configurations. Since the number of sill decks, their length, and the length of the sill bodies is not limited, a wide range of configurations can be realized. Here are several examples. The sill assembly 200 of FIGS. 29 and 30 can be extended on the right-hand side to accommodate more sidelites. Alternatively, the sill assembly could be reversed so two of the sidelites 204 of FIG. 31 would be on the right-hand side with one of the sidelites 204 of FIG. 31 being on the left-hand side. The portion of the sill body 201 not covered by the sill decks 202 can be extended to accommodate one or more pairs of French doors. The sill decks 202 can extend across the entire sill body to accommodate only sidelites 204 in order to form a window wall. Virtually any number of sill decks 202 can be used.

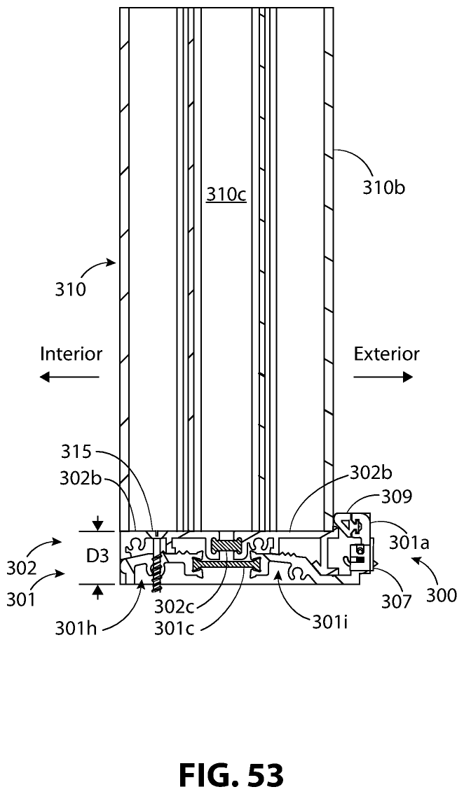

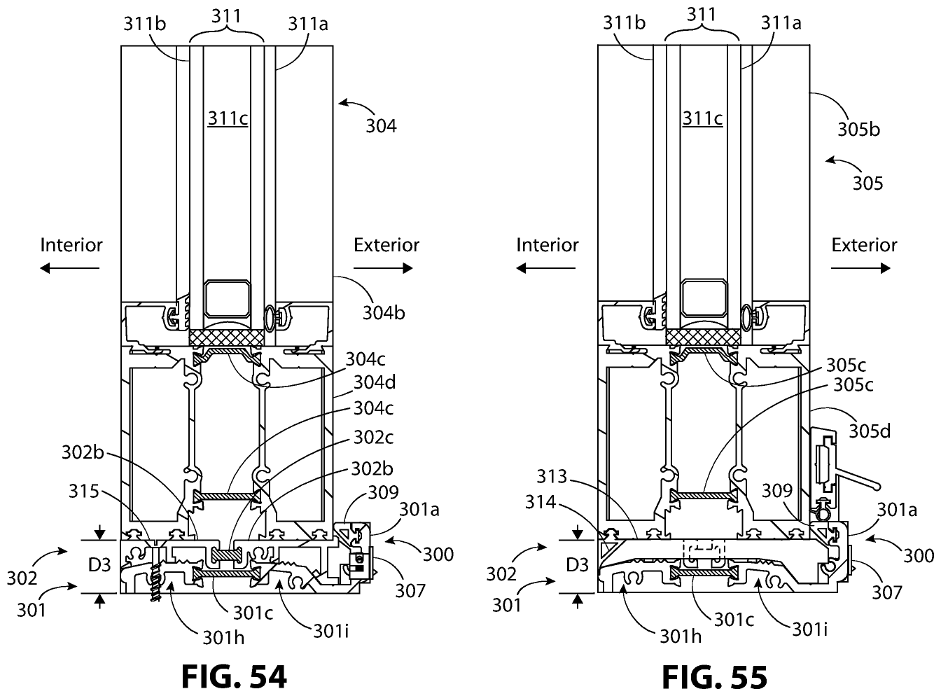

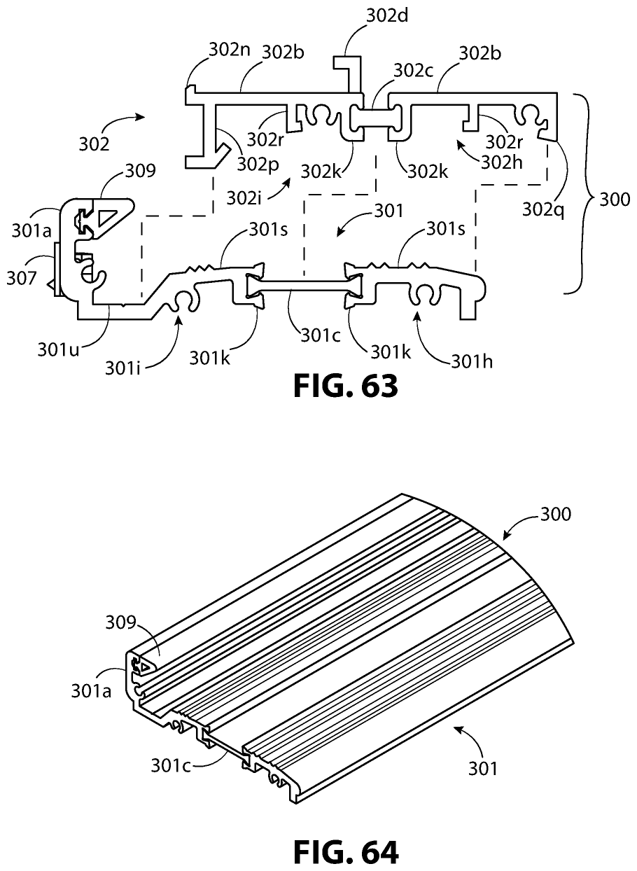

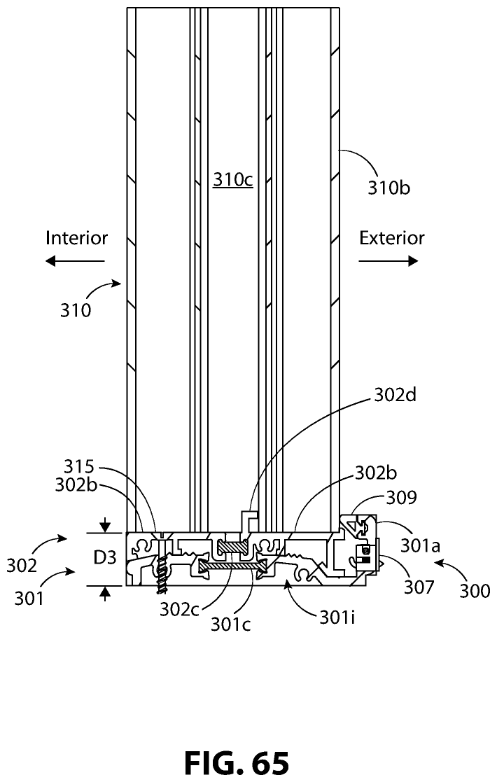

FIGS. 44-67, and 69 illustrate an example of a continuous sill for use with an inswing door and one or more sidelites. The sill assembly 300 of FIGS. 57-67, and 69, includes alignment portions 302d (shown in FIGS. 57-63, 65, 66, and 69) for aligning and securing sidelites and vertical jambs. The sill assemblies 300 of FIGS. 44-56 do not include alignment portions. Referring to FIGS. 44-50, 53-55, 57-63, 65-67, and 69 the sill assembly 300 includes two main portions: The sill body 301 and one or more of the sill decks 302. The sill decks 302 are illustrated extending from the back of the sill body 301 to the front lengthwise edge of the sill body 301. The sill body 301 acts as threshold for the door 305 (see FIGS. 51, 52, 55, and 67) and together with the end dams 303 (FIGS. 44-49, 51, 52, 56-62) act as sill pan. The sill decks 302 are mounted and secured over the sill body 301 and provide horizontal surfaces 302b (FIGS. 44-47, 49, 50, 53, 54, 57-60, 62, 63, 65, 66, and 69) for the bottom surfaces of the sidelites 304 (FIGS. 54, 66, and 69) and the bottom surfaces of the vertical jambs 310 (FIGS. 53 and 65) to mount against.

Referring to FIGS. 53, 54, 65, 66, and 69, the sill decks 302 raises the sidelite 304 (FIGS. 54, 66, and 69) and vertical jamb 310 (FIGS. 53 and 65) a distance D3 above the floor level. Referring to FIGS. 51, 52, 55, and 67, the door 305 closes directly over the sill body 301. Referring to FIGS. 55 and 67, the bottom of the door bottom rail 305d sits above the floor level a distance D3 allowing clearance for the door to swing. Referring to FIGS. 53-55, 65-67, and 69 this arrangement aligns the bottom lengthwise edge of the sidelite bottom rail 304d (FIGS. 54, 66, and 69), the bottom lengthwise edge of the door bottom rail 305d (FIGS. 55 and 67), and the bottom lengthwise edge of the vertical jamb 310 (FIGS. 53 and 65). Referring to FIGS. 55 and 67, the sill deck covers 313 are behind the door 305. The door sweep 314 provides weather sealing from the outside elements. The weep flap 307 facing the exterior environment, allows accumulated water to drain to the outside.

Referring to FIGS. 54, 66, and 69, the thermal breaks 301c, 302c of the sill body 301 and the sill decks 302, respectively, can align, as illustrated, under the thermal break 304c of the sidelite 304. Referring to FIGS. 53 and 65, the thermal breaks 301c, 302c of the sill body 301 and the sill decks 302, respectively, can align, as illustrated, under hollow cavity 310c between thermal breaks (not shown) of the vertical jamb 310. Referring to FIGS. 55 and 67, in the closed position, the thermal breaks 301c of the sill body 301 can be aligned, as illustrated, under the thermal breaks 305c of the door 305. By the alignment described above, the inside-facing side of the door 305, the vertical jamb 310, the sidelite 304, sill body 301, and sill decks 302 can be thermally isolated from the exterior environment. Referring to FIGS. 54, 55, 66, 67, and 69, this includes the glazing panels 311 which are illustrated as an IGU. The glazing panels 311 can include a first glass panel 311a and a second glass panel 311b separated by a cavity 311c filled with either air or gas.

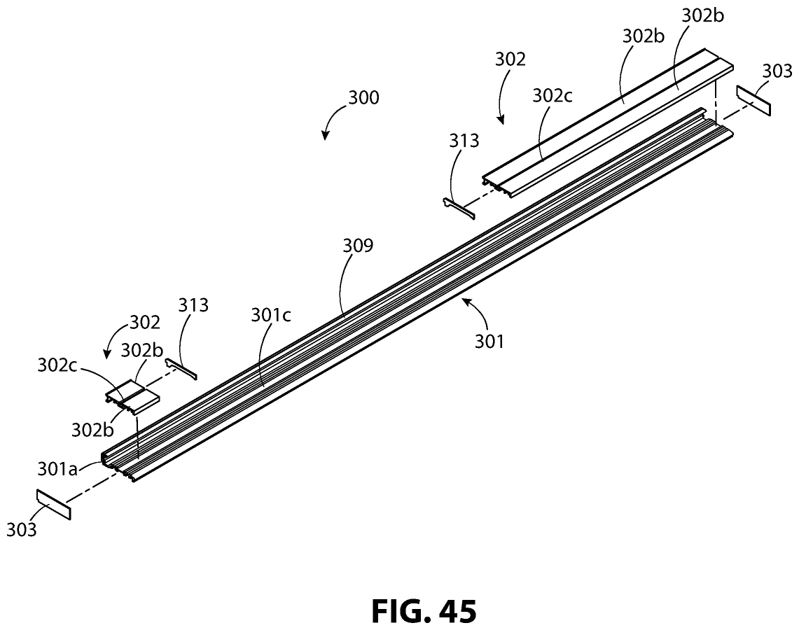

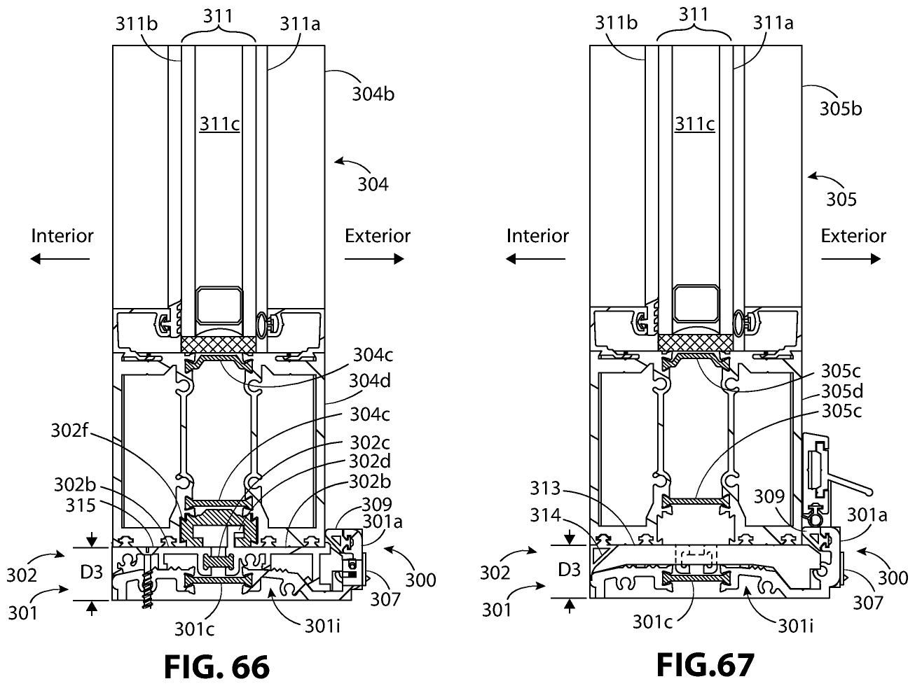

Referring to FIGS. 54, 66, and 69, seal 309 helps to create an air-tight seal between the sill backstop 301a and the sidelite 304. As previously described, the seal is typically a silicone sealant, but can also be other watertight sealants such as an adhesive sealant tape. Referring to FIGS. 45, 47-49, 50, 53-55, 58, and 60-67, and 69, the seal 309 can run either continuously, or in sections, across the sill backstop 301a in its entirety. This allows the seal 309 to create an air seal across the sidelite 304 (FIGS. 54, 66, and 69), the door 305 (FIGS. 55 and 67), and the vertical jamb 310 (FIGS. 53 and 65). Referring to FIGS. 53-55, 65-67, and 69, the rear surfaces of the sidelite stiles 304b and sidelite bottom rail 304d (FIGS. 54, 66, and 69), the door stiles 305b and door bottom rail 305d (FIGS. 55 and 67), and the vertical jamb 310 (FIGS. 53 and 65) are all aligned against the sill backstop 301a, via the seal 309, in the same plane. If the sidelite stiles 304b, sidelite bottom rail 304d, door stiles 305b, door bottom rail 305d, and the vertical jamb 310 are all the same thickness, then their front surfaces would also lie in the same plane, which could be aesthetically desirable. Referring to FIGS. 65, 66, and 69, the alignment portion 302d can align the sidelite 304 (FIGS. 66 and 69) and the vertical jamb 310 (FIG. 65) against the sill backstop 301a in the same plane. Referring to FIGS. 54, 66, and 69, the alignment portion 302d can also align the thermal break 302c of the sill decks 302 with the thermal breaks 304c and the cavity 311c of the glazing panels 311. Referring to FIG. 66, the alignment portion 302d can also help secure the sidelite 304 to the sill decks 302 by a receiver 304f fitted within the sidelite 304. Here the receiver 304f is shown as a gasket fitted within a euro groove of the sidelite 304. However, the receiver 304f can be an integrally formed portion of the sidelite 304 or could be the euro groove itself. Referring to FIG. 63, the alignment portion 202d can be L-shaped with the stem of the alignment portion 302d extending upward from the horizontal surface 302b of the sill decks 302. The arm of the alignment portion 302d extends toward the sill backstop 301a of the sill body 301 as illustrated. In FIG. 63, the stem of the alignment portion 302d extends vertically upward from the horizontal surface 302b and the arm of the alignment portion 302d extends perpendicularly away from stem of the alignment portion 302d and horizontally toward the sill backstop 301a. The alignment portion 302d is shown as being integrally formed with the sill decks 302. However, the alignment portion 302d can be rigidly secured to the alignment portion by welding, adhesive, rivets, threaded fasteners or any other method of securing that creates a rigid bond capable of withstanding the forces encountered for a given installation. As previously discussed, while the alignment portion 302d is shown as L shaped, it can be any shape capable of engaging the receiver 304f and aligning the sidelite 304. For example, the alignment portion 302d can be a simple upward projection where it could align the sidelite 304, allow it to slide, but would not be captively slidable as in the case of other shapes, for example an L-shaped bracket or a T-shaped bracket. The receiver 304f may optionally be shaped to captively and slidably engaging the receiver 304f. While not illustrated, the vertical jamb 310 of FIG. 65 can include a receiver that receives and engages the alignment portions 302d similar to that described for FIG. 66 or could include a portion that is sized and shaped to engage the alignment portion 302d in a similar manner as the receiver 304f of FIG. 66.

Referring to FIG. 69, the alignment portions 302d may optionally snap into the receiver 304f, directly into the euro groove, or directly into a portion of the sidelite 304 sized and shaped engage the alignment portions 302d and snap them in place. In FIG. 69, the sill deck 302 includes two of the alignment portions 302d. Each of the alignment portions 302d is illustrated as barbed or hooked. The upper part is angled downward and thinner than the main stem allowing it to flex. The upper portions of the alignment portions 302d project downward away from each other. This arrangement allows the sidelite 304 to be pressed downward against the receiver 302f and snap into place. As the sidelite 304 is pressed downward, the upper part of the alignment portions flex inward, allowing the alignment portions 302d to pass through the opening in the alignment portion. Once the alignment portions 302d pass through the opening and the pressure is release from the upper portions of the alignment portion 302d, the upper portions well expand out to their resting position as illustrated thereby securing the sidelite 304 to the sill deck 302. The alignment portion 302d and the receiver 302f of FIG. 69 can be similarly applied to the vertical jamb 310 of FIG. 65. The receiver 302f can be a separate member as illustrated in FIG. 69, or could be a portion of the vertical jamb sized and shaped to engage the receiver and snap it in place.

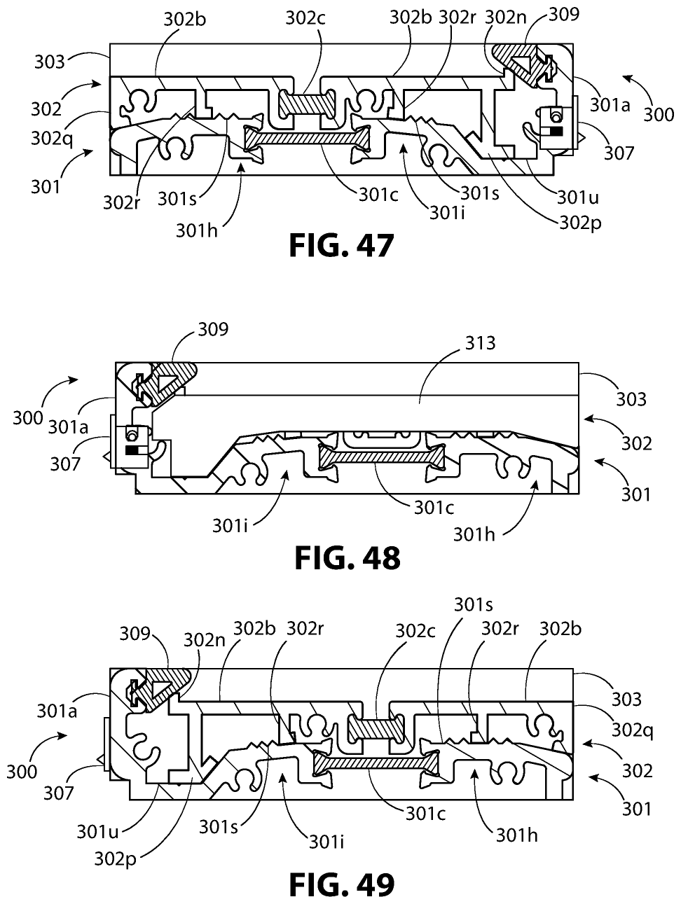

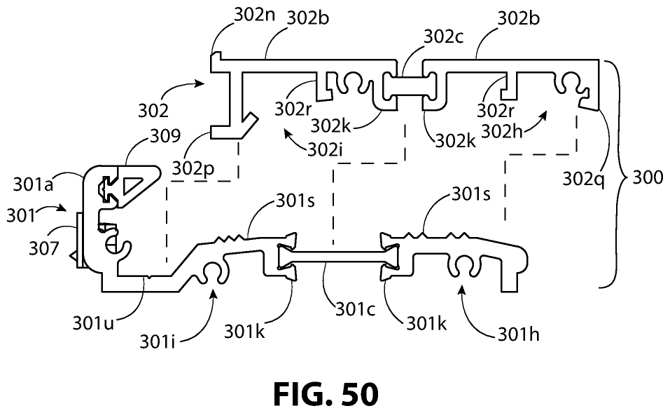

Referring to FIGS. 47, 49, 50, 60, 62, and 63, the sill decks 302 mounts to the sill body 301 as follows. The sill decks 302 include a sill deck backstop 302n projecting upwardly at the end of the rear sill deck portion 302i (FIGS. 50 and 63). The sill deck backstop 302n can project perpendicularly upward from the rear sill deck portion 302i, as illustrated in order to align sidelites 304 of FIGS. 54 and 66 and the vertical jambs 310 of FIGS. 53 and 65. A first mounting portion 302p projects downwardly away from the end of the rear sill deck portion 302i and rests against the drain channel 301u. The front sill deck portion 302h and the rear sill deck portion 302i each include a mounting portion 302r that projects downward from their respective bottom surfaces. Each of the mounting portions 302r includes a foot that planarly engages the top surfaces 301s of respective front sill portion 301h and rear sill portion 301i of the sill body 301. The front surface 302q of the sill deck 302 rests against the sill body 301. Referring to FIGS. 65, 66, and 69, the sill deck 302 can be fastened to the sill body 301 by a threaded fastener 315. The threaded fastener 315 can be any threaded fastener suitable for holding the sill deck to the sill and be able to withstand typical forces experienced by vertical jambs, mull posts, and sidelites as appropriate. Referring to FIGS. 47, 49, 50, 60, 62, and 63, one of the advantages of the sill assembly 300 is that the threaded fastener 315 of FIGS. 65, 66, and 69 is positioned entirely over the rear sill portion between the first mounting portion 302p and the mounting portion 302r of the rear sill deck portion 302i (FIGS. 50 and 63). This isolates any potential water leakage through the threaded fastener 315 to the environmentally exposed side of the sill assembly 300. Any water leaking through the threaded fastener 315, would roll down the top surface 301s of the rear sill portion 301i and drain out of the weep flap 307, on the sill backstop 301a.

Referring to FIGS. 50 and 63, the sill body 301 can include a front sill portion 301h and a rear sill portion 301i joined together by a thermal break 301c. The thermal break thermally isolates the front sill portion 301h from the rear sill portion 301i. The thermal strut is made of a thermally insulative material such as polyamide, as in the previous examples, is illustrated as a thermal strut. The thermal break 301c is also shown in FIGS. 44-50, 53-55, and 57-67, and 69. Continuing with FIGS. 50 and 63, the thermal breaks 301c can be crimped into grooves 301k in the front sill portion 301h and the rear sill portion 301i by large crimping rollers as previously described. This can create a watertight seal across the front sill portion 301h and the rear sill portion 301i. Silicone or other waterproof sealant can be placed along the lengthwise seams of the thermal break 301c to enhance water tightness. The sill backstop 301a extends directly upward from the rear sill portion 301i of the sill body 301 and defines the back portion of the sill body 301. The rear sill portion 301i and the sill backstop 301a are integral and have a unibody construction. Typically, this is accomplished by extrusion for a sill body made of aluminum. The sill backstop 301a is also shown in FIGS. 44-51, 53-67, and 69. Referring to FIGS. 50 and 63, the unibody construction assures that the inward-facing surface of the sill backstop 301a in combination with the rear sill portion 301i are sealed and waterproof. The sill body 301 in combination with the end dams 303 shown in FIGS. 44-49, 56-62 can create a watertight barrier with respect to surrounding wall structure and allows the sill body 301 to act both as a door threshold and a sill pan.

Referring to FIGS. 44-47, 49, 50, 53, 54, 57-60, 62, 63, 65, 66, and 69, the thermal breaks 302c thermally break the sill decks 302 between the front sill deck portion 302h and the rear sill deck portion 302i. The front sill deck portion 302h and the rear sill deck portion 302i are shown in FIGS. 50, and 63. Referring to FIGS. 50 and 63, the thermal break 302c can be crimped into grooves 302k in the front sill deck portion 302h and the rear sill deck portion 302i by large crimping rollers as previously described creating a watertight seal across the front sill deck portion 302h and the rear sill deck portion 302i. As previously described, silicone or other waterproof sealant can be placed also the lengthwise seams of the thermal break 302c to enhance water tightness.

Referring to FIGS. 44, 45, 48, 55, 57, 58, 61, and 67, sill deck covers 313 are attached to the sides of the sill decks 302. The sill deck covers 313 facing the door openings create a finished appearance for the side of the sill assembly 300. The sill deck covers 313 also contain any water run-off from the top of the sill decks 302 to within the sill body 301 under the sill decks 302. Referring to FIGS. 53, 54, 65, 66, and 69, the sidelites 304 (FIGS. 54 and 66) and the vertical jamb 310 (FIGS. 53 and 65) can be placed directly on the horizontal surfaces 302b of their respective 302 sill decks. They can also be placed with waterproofing silicone or a water-resistant gasket which would reduce the risk of water infiltration onto the sill decks 302. Referring to FIGS. 47-50, 53-55, 60-63, 65-67, and 69, a weep flap 307, or alternatively a weep hole, can optionally be positioned through the backstop of the sill body 301. The top surface 301s of the rear sill portion 301i are angled downward toward the rear of the sill body 301. Any water that might accumulate on the sill decks 302 and leak through to the sill body 301 via seal 309 would tend to flow to the front of the sill body 301, into the drain channel 301u (FIGS. 47, 49, 50, 60, 62, 63) and drain out the weep flaps 307.

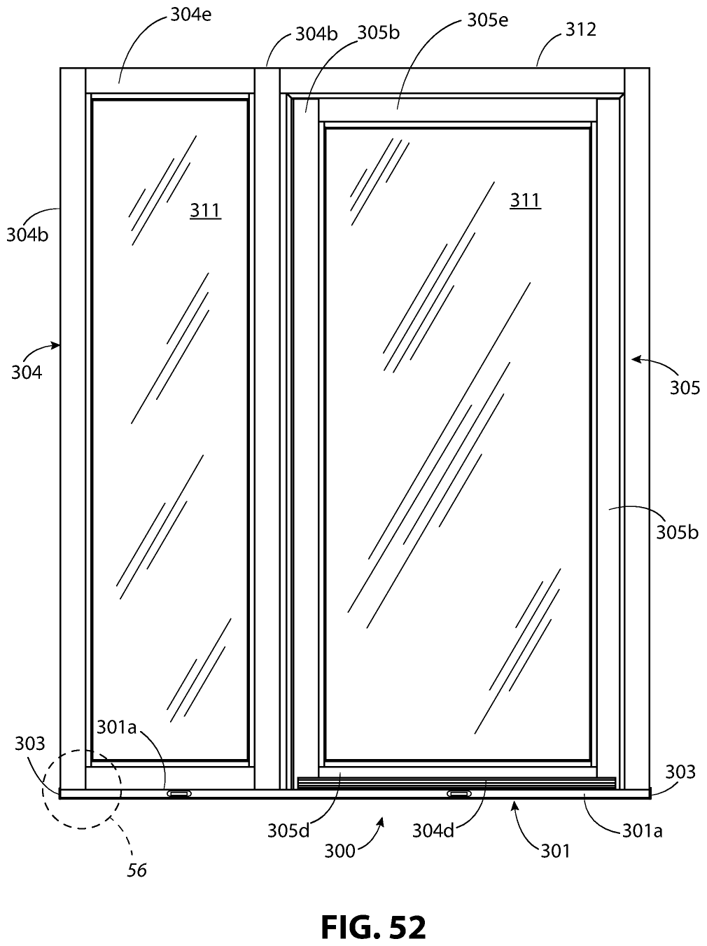

Referring to FIGS. 51 and 52, the doorway shown is configured similarly to the doorway of FIGS. 21 and 22 with the top of the frame of the doorway including the sidelite top rail 304e, header 312, top of the sidelite stiles 304b, and top of the vertical jamb 310. Glazing panel 311 of the door 305 is surrounded on either side by door stiles 305b, on the top by door top rail 305e, and on the bottom by door bottom rail 305d. Glazing panel 311 of the sidelite 304 is surrounded on the either side by sidelite stiles 304b, on the top by sidelite top rail 304e, and on the bottom by sidelite bottom rail 304d.

The preceding paragraphs described a doorway that includes a novel sill assembly. It is not the intent of this disclosure to limit the claimed invention to the examples, variations, and exemplary embodiments described in the Description or other sections of this Specification. Those skilled in the art will recognize that variations will occur when embodying the claimed invention in specific implementations and environments. For example, while all of the examples show a combination of one or more sidelites and one or more doors, it is possible to implement each of the examples with only fixed glazing, (i.e., no door). For example, a window wall. For example, for the sill assembly 100 of FIGS. 1-13, a series of spacers 107 and spacer block 108 can be placed across the entire sill body so that two or more are located under each fixed glazing structure. The fixed glazing structures can be constructed similar to the sidelite 104 of FIGS. 7-10, and 70. Similarly, the sill decks 202 can extend across the entirety of the sill assembly 200 of FIGS. 14-43, and 68, and the sill deck 302 can extend across the entirety of the sill assembly 300 of FIGS. 44-67, and 69 to accommodate a window wall. As in the example above, the fixed glazing of the window wall can be constructed similarly to the sidelites 204, 304.

The examples of FIGS. 1-71 illustrate typical installations with one door and one or more sidelites. It is well within the scope of this disclosure to include additional doors, French doors, or a wall of French doors. For the sill assembly 100 of FIGS. 1-13, 70, and 71, the French doors can be mounted directly over the sill body 101 as with a single swing door. The vertical jambs and optional astragal can be mounted directly to the sill body 101. Similarly, in FIGS. 14-69, the French doors can be mounted directly over the sill body 201, 301. The vertical jambs and optional astragal can be mounted over sill decks 202, 302.

The sill body 101 of FIGS. 1-13, 70, and 71, the sill body 201 and sill decks 202 of FIGS. 14-43, and 68, and the sill body 301 and sill deck 302 of FIGS. 44-67, and 69, are shown as thermally broken. This is often desirable when these components are extruded, cast, or otherwise formed from a thermally conductive material, such as aluminum or steel, especially in colder climates. The inventor envisions that the sill bodies 101, 201, 301 and sill decks 202, 302 could continuous and not thermally broken. For example, the components could be molded, extruded or otherwise formed from a material with low thermal conductivity such as high impact plastics, fiberglass, compost, or vinyl. Alternatively, the components could be extruded, cast, or otherwise formed from a thermally conductive material such as aluminum or steel for installations where thermal isolation is not important. For example, within an enclosed shopping mall. Referring to FIGS. 1-6, 10-12, 70, and 71, the horizontal surfaces 101b separated by a thermal break 101c could instead be continuous from front to back instead of being thermal broken. In the context of a shopping mall or other applications within a protected environment, and inswing door would open from the general environment into a specific area, such as a store or office. An outswing door would open from the specific area into the general environment. Referring to FIGS. 14-17, 19, 20, 23, 25, 29, 30, 33-37, 39, 42, 43, and 68, the horizontal surfaces 202b separated by thermal breaks 202c could instead be continuous from front to back. Referring to FIGS. 17-20, 23-25, 36-39, 41-43, and 68, the front sill portion 201h and the rear sill portion 201i separated by thermal breaks 201c could also be continuous from front to back instead of being thermally broken. Referring to FIGS. 44-47, 49, 50, 53-54, 57-60, 62, 63, 65, 66 and 69, the horizontal surfaces 302b separated by thermal breaks 302c could instead be continuous from front to back. Referring to FIGS. 47-50, 53-55, 60-62, and 63, front sill portion 301h and the rear sill portion 301i separated by thermal breaks 301c could also be continuous from front to back instead of being thermally broken.

While separate flashing is often not required, the installer may opt to install additional flashing or self-sealing waterproof adhesive membrane if they deem necessary or if required by local building codes. Installing additional flashing or self-sealing waterproof adhesive membrane is well within the scope of the sills of this disclosure.

Throughout this disclosure, the infill panel has been illustrated as glazing panels. For example, the glazing panel 111 of FIGS. 7-11, and 70 glazing panel 211 of FIGS. 21-24, 27, 28, 31, 32, 41, 42, and 68, and glazing panel 311 of FIGS. 51, 52, 54, 55, 66, 67, and 69. The inventor envisions that some of this can be readily substituted with solid infill panels such as composite or wood and remain within the spirit of the inventive concept.

It is possible to implement certain features described in separate embodiments in combination within a single embodiment. Similarly, it is possible to implement certain features described in single embodiments either separately or in combination in multiple embodiments. For example, the sill assembly 100 of FIGS. 1-13 can incorporate the alignment portion 202d of FIGS. 33-39, 42, and 43 or the alignment portion 302d of FIGS. 57-63 and 65, 66, and 69. The inventor envisions that this and other variations fall within the scope of the claimed invention. Just as the alignment portions 302d of FIG. 69 could be replace the alignment portions 302d of FIGS. 65 and 66 by following the explanation for FIG. 69, the alignment portions 302d of FIG. 69 could similarly replace the alignment portion 202d of FIGS. 42 and 43. This could allow the sidelite 204 to snap into place against the sill deck 202. Similarly this could allow the vertical jamb 210 to snap into place against the sill deck 202.

While the examples, exemplary embodiments, and variations are helpful to those skilled in the art in understanding the claimed invention, it should be understood that, the scope of the claimed invention is defined solely by the following claims and their equivalents.

What is claimed is:

1. A sill assembly for a door, a sidelite, a vertical door frame member, comprising:
a sill body extending continuously under the door, the sidelite, and the vertical door frame member;
the sill body including a backstop extending vertically upward from the sill body and across its entire length, the backstop defining a lengthwise back edge of the sill body; and
back surfaces of the sidelite, the door, and the vertical door frame member align in the same plane against the backstop.

2. The sill assembly of claim 1 wherein the sill assembly includes horizontal surfaces for seating the sidelite and the vertical door frame member.

3. The sill assembly of claim 1 wherein the sidelite and the vertical door frame member are secured to the backstop.

4. The sill assembly of claim 1, further comprising:
a first end dam and a second end dam positioned on opposing ends of the sill body and comprising a watertight barrier between the sill body and a surrounding wall opening.

5. The sill assembly of claim 1, wherein:
the sill body includes a thermal break; and
corresponding thermal breaks in the door and sidelites align over the thermal break of the sill body.

6. The sill assembly of claim 1, wherein bottom lengthwise edges of the door, the sidelite, and the vertical door frame member are linearly aligned.

7. The sill assembly of claim 1, further including:
a first sill deck, positioned over the sill body and extending from the backstop to a front lengthwise edge of the sill body;
the first sill deck includes a first horizontal surface and the sidelite seated on the first horizontal surface;
a second sill deck, positioned over the sill body and extending from the backstop to the front lengthwise edge of the sill body;
the second sill deck includes a second horizontal surface and the vertical door frame member seated on the second horizontal surface.

8. The sill assembly of claim 7, wherein bottom lengthwise edges of the door, the sidelite, and the vertical door frame member are linearly aligned.

9. The sill assembly of claim 7, wherein:
the sill body includes a first thermal break and the first sill deck includes a second thermal break; and
corresponding thermal breaks in the door and sidelites align over the first thermal break and the second thermal break.

10. The sill assembly of claim 9, further including:
a first alignment portion extending secured to and extending upward from the first sill deck;
a receiver positioned within the sidelite; and
the first alignment portion captively engages the receiver, the receiver in combination with the first alignment portion aligns the sidelite over the first sill deck and against the backstop.

11. The sill assembly of claim 10, further including:
a second alignment portion secured to and extending upward from the second sill deck and into the vertical door frame member; and
the second alignment portion aligns the vertical door frame member over the second sill deck and against the backstop.

12. The sill assembly of claim 7, further including:
a first alignment portion extending secured to and extending upward from the first sill deck;
a receiver positioned within the sidelite; and
the first alignment portion captively engages the receiver, the receiver in combination with the first alignment portion aligns the sidelite over the first sill deck and against the backstop.

13. The sill assembly of claim 12, further including:
a second alignment portion secured to and extending upward from the second sill deck and into the vertical door frame member; and
the second alignment portion aligns the vertical door frame member over the second sill deck and against the backstop.

14. The sill assembly of claim 7 wherein the sidelite and the vertical door frame member are secured to the backstop.
